(19) United States
(12) Patent Application Publication
(10) Pub. No.: US 2007/0104096 A1
(43) Pub. Date: May 10, 2007

(54) Next generation network for providing diverse data types

(75) Inventor: Patrick Ribera, Paris (FR)

Correspondence Address: HOGAN & HARTSON LLP;IP GROUP, COLUMBIA SQUARE, 555 THIRTEENTH STREET, N.W., WASHINGTON, DC, 20004, US

(73) Assignee: LGA Partnership

(21) Appl. No.: 11/440,454

(22) Filed: May 25, 2006

Related U.S. Application Data
(60) Provisional application No. 60/684,157, filed on May 25, 2005.

(51) Int. Cl. H04L 12/26

(52) U.S. Cl. 370/229

(57) ABSTRACT

A data-processing network based on a new Internet protocol features a modified addressing system, a novel routing method, resolution of congestion problems in the routers, differentiated transport of data, real-time videos and communications, a multicast system to distribute real-time videos, and data transport with quality of services. The network uses homogeneous network protocol to transport multi-cast, real-time stream, and file data over the same network and to provide multiple qualities of service. Multi-packets may be unpacked at any node for predictive and reactive congestion control and dynamic packet routing. Specifically, a network node updating adjacent nodes with its congestion status, so that each node dynamically routes data away from any congested nodes and prioritizes higher quality of service traffic. In routing data, paths not stored in data packets, but instead, paths are dynamically recomputed around congestion or failed nodes and multicast data is routed using bread crumb trail techniques.

### CROSS REFERENCE TO RELATED APPLICATIONS

This application claims benefit of U.S. Provisional Application No. 60/684,157 filed May 25, 2005, and the subject matters of that application is hereby incorporated by reference in full

### BACKGROUND OF THE INVENTION

1. Field of the Invention

The present invention provides a new generation data-processing network based on a new Internet protocol that features a modified addressing system, a novel routing method, resolution of congestion problems in the routers, differentiated transport of data, real-time videos and communications, a new multicast system to distribute real-time videos, and transport with quality of services.

2. Discussion of the Related Art

The worldwide development of the Internet entailed very important evolutions, both in the networking technology and in the services they provided to the public. Generally put, the Internet is a world-wide collection of separate computer networks. These individual networks are interconnected with one another and permit the transfer of data between computers or other digital devices. The Internet requires a common software standard that allows one network to interface with another network. By analogy, the computers connected to the Internet must speak the same language in order to communicate. The Internet may use a myriad of communications media, including, but not limited to telephone wires, satellite links, and even the coaxial cable used for traditional cable television.

Because the composite network is so expansive, users connected to the Internet may exchange electronic mail messages (e-mail) with individuals throughout the world; post information at readily accessible locations on the Internet so that others may readily access that information (e.g., web pages or entire web sites); and access multimedia information that includes sound, photographic information, video or other entertainment-related information. Moreover, and perhaps even more importantly, the Internet connects together cultures and societies from throughout the and allows individuals to obtain information from a number of different and diverse sources.

It is believed The Internet began as a United States Department of Defense project to assemble a network of computers that, due to its global proportions, would be able to remain functional in the event of a catastrophic disaster. The first entities using the Internet, though not necessarily in its more modern form, were academic institutions, scientists and governments. The primary purpose of this network was the communication of research and sensitive information. In about 1992, the Internet was offered to the public by commercial entities for the first time. This led to what has become the modern-day Internet which reaches countless individuals and distributes more data faster than was ever imaginable back in its infancy.

The transmission speeds on the networks embodying the Internet have changed dramatically over the years, from tens to billions bits per second. This remarkable growth is due to a number of technological innovations, including the use of dense wavelength division multiplexing (DWDM) technology, faster processors implemented at routers and other network locations, and the use of optical fiber and coaxial cable as a transmission medium. This evolution has followed that of the processor, whose computing power has increased dramatically over the last 20 years. These processors have been implemented in routers, giving rise to gigabit routers and terabit routers able to process enormous volumes of information for transmission over the various networks constituting the Internet. Furthermore, the development of sophisticated optical fiber technology has led to an immense increase in the bandwidth that the Internet can handle.

Over the past few years, there has been an extensive development of multimedia formats and coding techniques which have enabled and facilitated things that were otherwise thought impossible over 20 years ago, such as the ready distribution of audio and video to a desktop or laptop computer. The development of these coding techniques and data compression make it theoretically possible to use an internet protocol (“IP”) network to broadcast television, though in its current state, the Internet may likely not be able to handle the data load that the distribution of television would place on the Internet. Also, with the advent of more sophisticated computer networks, more sophisticated telephony systems have emerged. These telephone network include the adoption of Internet-based data-processing networks and the use of packetized voice and, gradually, transport under IP.

As described above, the Internet is a network of networks running different low-level protocols, and IP is the network level, or level 3, protocol that unifies these different networks. IP is a data-oriented protocol used by source and destination hosts for communicating data across a packet-switched internetwork. Internetworking involves connecting two or more distinct computer networks together into an internetwork (often shortened to internet) using devices called routers to connect the networks, to allow traffic to flow back and forth between them. The routers guide traffic on the correct path, selected from the multiple available pathways, across the complete internetwork to their destination.

In the Internet, a server is a computer software application that carries out some task (i.e. provides a service) on behalf of yet another piece of software called a client. Server may also alternatively refer to the physical computer on which the server software runs. In the case of the Web, an example of a server is the Apache® web server, and an example of a client is the Internet Explorer® web browser. Other server (and client) software exists for other services such as e-mail, printing, remote login, and even displaying graphical output. This is usually divided into file serving, allowing users to store and access files on a common computer; and application serving, where the software runs a computer program to carry out some task for the users, and typically web, mail, and database servers are what most people access when using the Internet.

In IP, data is sent in blocks referred to as packets or datagrams, and a data transmission path is setup when a first host tries to send packets to a second host. As described in greater detail below, the packets, or the units of information carriage, are individually routed between nodes over data links which might be shared by many other nodes. Packet switching is used to optimize the use of the bandwidth available in a network, to minimize the transmission latency, the time it takes for data to pass across the network, and to increase robustness of communication.

The package switching, also called connectionless networking, contrasts with circuit switching or connection-oriented networking, which sets up a dedicated connection between the two nodes for their exclusive use for the duration of the communication. Technologies such as Multiprotocol Label Switching (“MPLS”) are beginning to blur the boundaries between the two. MPLS is a data-carrying mechanism operating in parallel to IP at a the network layer to provide a unified data-carrying service for both circuit-based clients and packet-switching clients, and thus, MPLS can be used to carry many different kinds of traffic such as the transport of Ethernet frames and IP packets. Similarly, Asynchronous Transfer Mode (“ATM”) a hybrid cell relay network protocol which encodes data traffic into small fixed-sized cells, typically 53 bytes with 48 bytes of data and 5 bytes of header information, instead of variable sized packets as in packet-switched networks (such as the Internet Protocol or Ethernet).

In the packet switching used by the IP, a file is broken up into smaller groups of data known as packets. A packet is a block of data (called a payload) with address and administrative information attached to allow a network of nodes to deliver the data to the destination. A packet is analogous to a letter sent through the mail with the address written on the outside. Thus, the packets used in IP typically carry information with regard to their origin, destination and sequence within the original file. This sequence is needed for re-assembly at the file's destination.

Packets are routed to their destination through the most expedient route as determined by some known routing algorithm, and the packets traveling between the same two nodes may follow the different routes. One data connection will usually carry a stream of packets from several nodes. As described in greater detail below, IP routing is performed by all hosts, but most importantly by internetwork routers, which typically use either interior gateway protocols (IGPs) or external gateway protocols (EGPs) to help make IP datagram forwarding decisions across IP connected networks. The destination node reassembles the packets into their appropriate sequence.

IP provides an unreliable datagram service, also called best effort, in that IP makes almost no guarantees about the packet. The packet may arrive damaged, it may be out of order (compared to other packets sent between the same hosts), it may be duplicated, or it may be dropped entirely. For example, the User Datagram Protocol (UDP) of IP is a minimal message-oriented transport layer protocol that provides a very simple interface between a network layer below and an application layer above. UDP provides no guarantees for message delivery and a UDP sender retains no state on UDP messages once sent onto the network. UDP adds only application multiplexing and data checksumming on top of an IP datagram. Lacking reliability, UDP applications must generally be willing to accept some loss, errors or duplication. Often, UDP applications do not require reliability mechanisms and may even be hindered by them, and streaming media, real-time multiplayer games and voice over IP (VoIP) are examples of applications that often use UDP. Lacking any congestion avoidance and control mechanisms, network-based mechanisms are required to minimize potential congestion collapse effects of uncontrolled, high rate UDP traffic loads. In other words, since UDP senders cannot detect congestion, network-based elements such as routers using packet queuing and dropping techniques will often be the only tool available to slow down excessive UDP traffic. The Datagram Congestion Control Protocol (DCCP) is being designed as a partial solution to this potential problem by adding end host congestion control behavior to high-rate UDP streams such as streaming media.

The lack of any delivery guarantees in IP means that the design of packet switches is made much simpler. If the network does drop, reorder or otherwise damage a lot of packets, the performance seen by a user will be poor, so most network elements do try hard to not do these things, and hence networks generally make a best effort to accomplish the desired transmission characteristics. However, an occasional error will typically produce no noticeable effect in most data transfers.

If an application needs reliability, it is provided by other means, typically by upper level protocols transported on top of IP. For example, Transmission Control Protocol (“TCP”), one of the core protocols of the Internet protocol suite allows applications on networked hosts to create connections to one another to exchange data to better guarantee reliable and in-order delivery of sender to receiver data. TCP operates at the transport layer between IP and applications to provide reliable, pipe-like connections streams that are not otherwise available through the unreliable IP packets transfers. In TCP, Applications send streams of 8-bit bytes for delivery through the network, and TCP divides the byte stream into appropriately sized segments (usually delineated by the maximum transmission unit (MTU) size of the data link layer of the network the computer is attached to). TCP then passes the resulting packets to the Internet Protocol, for delivery through an internet to the TCP module of the entity at the other end. TCP checks to make sure that no packets are lost by giving each packet a sequence number, which is also used to make sure that the data are delivered to the entity at the other end in the correct order. The TCP module at the far end sends back an acknowledgement for packets which have been successfully received; a timer at the sending TCP will cause a timeout if an acknowledgement is not received within a reasonable round-trip time (or RTT), and the (presumably lost) data will then be re-transmitted. The TCP checks that no bytes are damaged by using a checksum; one is computed at the sender for each block of data before it is sent, and checked at the receiver. Thus, it can be seen that TCP adds substantially complexity and potential delays to network data transfers to accomplish improved reliability.

The current and most popular IP in use today is IP Version 4 (“IPv4”) that uses 32-bit addresses. A complete description of the IPv4 is beyond the scope of the present discussion, and more information IPv4 can be found in IETF RFC 791. IPv4 supports the use of network elements (e.g. point-point links) which support small packet sizes. Rather than mandate link-local fragmentation and reassembly, which would require the router at the far end of the link to collect the separate pieces and reassemble the packet (a complicated process, especially when pieces may be lost due to errors on the link), a router which discovers that a packet which it is processing is too big to fit on the next link is allowed to break it into fragments (separate IPv4 packets each carrying part of the data in the original IPv4 packet), using a standardized procedure which allows the destination host to reassemble the packet from the fragments, after they are separately received there.

When a large IPv4 packet is split up into smaller fragments (which is usually, but not always, done at a router in the middle of the path from the source to the destination), the fragments are all normal IPv4 packets with a full IPv4 header. The original packet's data portion is split into segments which are small enough (when appended to the requisite IPv4 header) to fit into the next link such that one segment of the original data is placed in each fragment. All the fragments will have the same identification field value, and to reassemble the fragments back into the original packet at the destination, the host looks for incoming packets with the same identification field value. The offset and total length fields in the packet headers tell the recipient host where each piece goes, and how much of the original packet it fills in, and the recipient host can work out the total size of the original packet from the data in the packet headers. The packets can be sent multiple times, with fragments from the second copy used to fill in the blank spots from the first one.

IP Version 6 (“IPv6”) is the proposed successor to IPv4, but is still in the early stages of implementation. IPv6 has 128-bit source and destination addresses to providing more addresses than IPv4's 32 bits, which are quickly being used up, and more information on IPv6 can be found in RFC 2460 (http://www.ietf.org/rfc/rfc2460.txt). In contrast to IPv4, only the host handles fragmentation in IPv6. For example, in IPv4, one would add a Strict Source and Record Routing (SSRR) option to the IPv4 header itself in order to enforce a certain route for the packet, but in IPv6 one would make the Next Header field indicate that a Routing header comes next. The Routing header would then specify the additional routing information for the packet, and then indicate that, for example, the TCP header comes next.

Despite the successfulness of IP and the Internet, there nevertheless, remains a need for significant advancements in fixed and mobile telephony, together with the development of video telephony and teleconferencing capabilities. This may entail the integration of data networks, multimedia networks and telephone networks into a single, uniform network. At present, the Internet is insufficient to provide these advanced applications. This is due to many deficiencies that have caused the Internet to have likely reached its practical limitations in terms of particular applications, information-carrying capacity, and quality of service, as described in greater detail below.

One cause for limitations in the Internet is that the network was originally designed for data transmission and is not optimized for the transmission of telephony signals or for the transmission of television over the Internet. This is, in part due to the above-described best effort form of data flow management that the Internet utilizes in routing data through the various networks constituting the Internet.

Also, as described above, the Internet is not a uniform network, but instead is an interconnected patchwork of various heterogeneous networks owned and maintained by various entities. Consequently, there are inherent difficulties in managing quality of service since deficiencies in any of the various networks potentially degrades overall system performance.

Furthermore, the currently used IPv4 and the proposed IPv6 that has yet to be employed on a widespread basis are relatively complicated in handling secure data transfers and large, fragmented data transfers, as described above.

Another concern with the Internet is that because of the amount of growth undergone over the past ten or fifteen years, there is a shortage of IP addresses in IPv4. While IPv6 would help solve this problem, there have been some difficulties in implementing this protocol.

A further problem with the Internet is that with the “best effort” mode, the Internet does not allow for consideration of a quality of service measures for newer services, such as video or telephony, despite the development of protocols that have been used to solve other issues with this type of data. Despite some attempts to implement a multicast system that will permit the distribution of television over the Internet, many specialists believe that there will be significant hurdles in applying this multicast system. Finally, because of the heterogeneous nature of the current Internet, any possible solutions will not be as effective as a complete Internet overhaul.

### SUMMARY OF THE INVENTION

Accordingly, in view of these and other deficiencies inherent in Internet, the present invention provides to a new generation data-processing network based on a new Internet protocol, which features a modified addressing system, a novel routing method, resolution of congestion problems in the routers, differentiated transport of data, real-time videos and communications, a new multicast system to distribute real-time videos, and transport with quality of services. The network provides households with a new, particularly attractive paradigm for entertainment, information, teaching, on-line stores, services and communication. Specifically, embodiments of the network promote media convergence by enabling a private worldwide Internet-type network coupled to a satellite-based network to distribute house-to-house worldwide, all the types of digital components and interactive services while also being the main tool for the transmission of worldwide fixed and mobile telephone calls, video-telephony and videoconferencing, and generalized exchanges of electronic documents.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIGS. 1A-1B, 2 and 15 depict a next generation network in accordance with embodiments of the present invention;

FIGS. 3A-3B, 4-6, and 10-11 depict data transfer formats used in the next generation network of FIGS. 1A-1B, 2, and 15 in accordance with embodiments of the present invention;

FIGS. 7A-7E are schematic diagrams of protocol stack levels depictions of the operation of the data transfer formats of FIGS. 3A-3B, 4-6, and 10-11 used in the next generation network of FIGS. 1A-1B, 2, and 15 in accordance with embodiments of the present invention;

FIGS. 8-9, 12, 14, 16, 18, 20, and 22 are flow charts depicting the steps in a data transmission method using the data transfer formats of FIGS. 3A-3B, 4-6, and 10-11 used in the next generation network of FIGS. 1A-1B, 2, and 15 in accordance with embodiments of the present invention;

FIGS. 13A-13D, 17A-17C, 19A-19D, 21A-21C, and 23 are schematic diagrams of node-to-node data transmissions using the data transmission method of FIGS. 8-9, 12, 14, 16, 18, 20, and 22 in accordance with embodiments of the present invention.

### DETAILED DESCRIPTION OF THE PREFERRED EMBODIMENTS

Reference will now be made in detail to various embodiments of the present invention, examples of which are illustrated in the accompanying drawings.

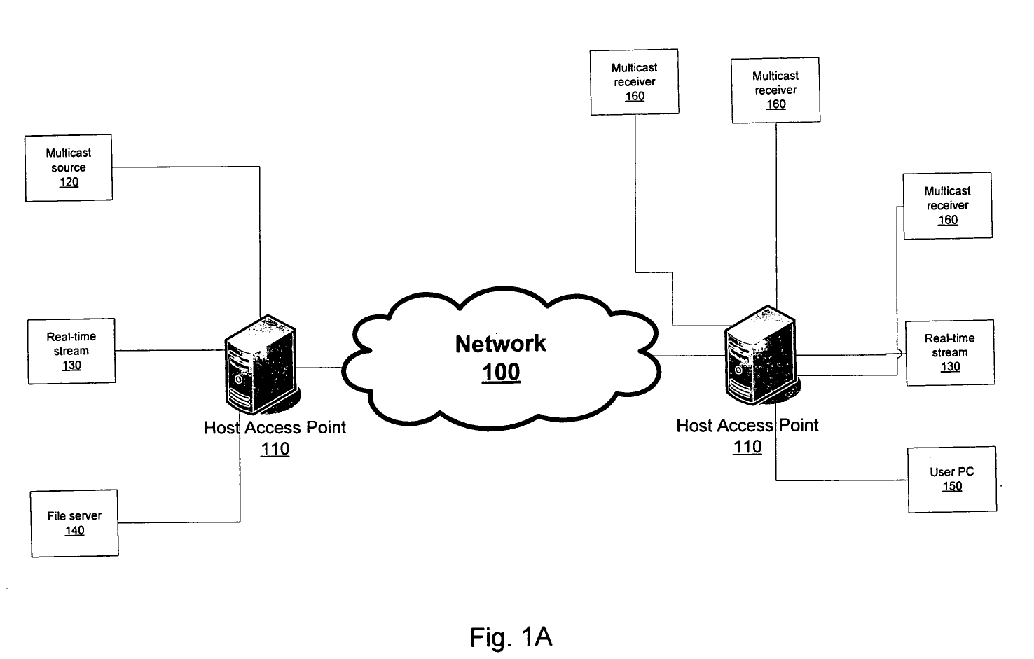

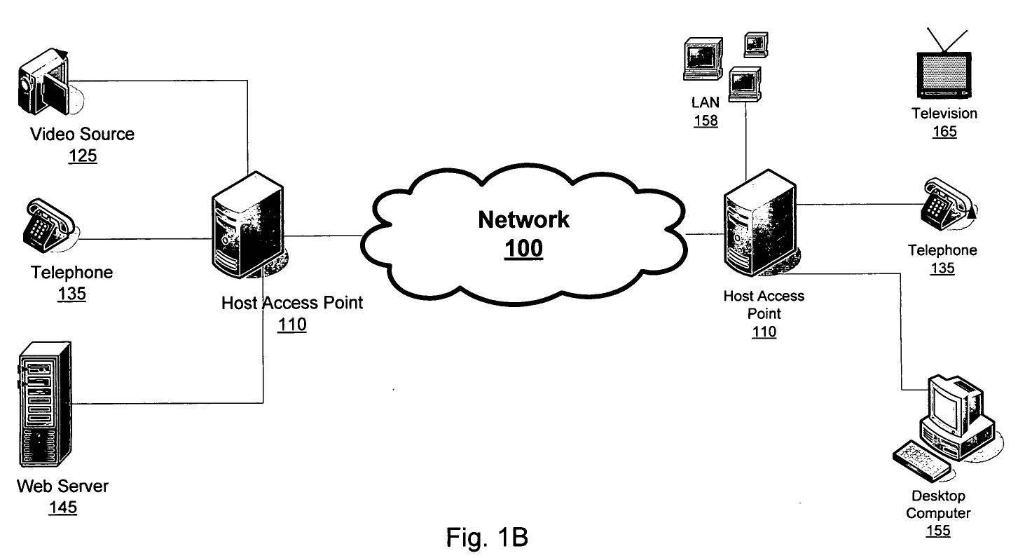

The present invention generally relates to the network 100 depicted in FIGS. 1A and 1B. The network 100 is homogeneous, in the sense that its internal nodes use the same protocols, and provides a data transport for different types of data, including real-time streamed data, multicast streamed data, and file data. All data is sent as a flow, and the requirements of the flow determine how it is treated within the network 100. The network 100 is capable of adapting dynamically to the different requirements of different kinds of data. This means that, for example, a television broadcast and a telephone call can travel over the same lines using the same routers even though the performance demands of both are quite different.

In order to ensure that quality of service demands are met for different types of data, the network 100 provides smart internal nodes that detect and respond to congestion in the network in an automatic way. The congestion handling is both predictive and reactive. It is predictive because a node monitors its own status and notifies its neighbors of any congestion. It is also reactive because a node monitors the speed of outgoing traffic, and can detect and respond to a slowdown by rerouting traffic away from congested nodes. The congestion control system prioritizes more critical data, so that faster routes are preserved for more demanding types of data, like real-time streams. Lower priority data is routed away from congestion first.

In embodiments of the present invention, routing between end-user devices is based on geographic addressing. Unlike standard IP addresses, a device's address (called a Multicast Evolution IP address or MEIP address) is typically largely determined by its physical location. This allows for packets to be routed long distances using coarse-grained routing that is progressively refined as the packet nears its destination. The overall geography of the network is divided into regions, which are then divided into subregions. Within subregions, end-user devices are connected to the network through host access points, which form the outer boundary of the network. The goal of routing is to get a packet first into the correct region (in the preferred embodiment this would be a country), then to the correct subregion, and lastly to the correct host access point. The result of this technique of routing is much smaller routing tables and correspondingly faster dynamic routing. In order to implement this routing scheme, device addresses are hierarchical; the first segment of the address identifies the region and the next identifies the subregion. In one embodiment, two segments are used to identify host access points and internal nodes. The first is an operator number, which is assigned to a telecommunications carrier. That carrier then assigns individual numbers to all of the nodes (including host access points) that it controls. Thus the two segments together uniquely identify any node within a subregion. Separating the operator number means that an operator can charge for the use of its equipment more easily. Lastly, each Host Access Point computer (“HAP”) 110 connected to user devices, and the last segment of the address identifies a user device for that HAP 110.

The network also defines specific boundary nodes for both subregions and regions. Region gateways connect regions. Edge routers connect subregions. The goal of the routing scheme is to get a packet first to the correct region, then to the correct subregion, then to the correct HAP, and lastly to the connected device. The hierarchical nature of the MEIP address means that a router only needs to maintain enough information to route packets to all of the HAPs within its subregion, all of the subregions in its region, and all of the regions in the network.

To do this, embodiments of the present invention provide a router that maintains three separate routing tables, one for regions, one for subregions, and one for HAPs. If a packet needs to be routed to another region, it will be directed towards an appropriate region gateway using the region routing table. If it needs to be routed to another subregion within the same region, it will be directed towards the appropriate edge router using the subregion routing table. If the packet is in the correct region and subregion, it will be directed towards the correct HAP using the HAP routing table.

As described in greater detail below, the data packet format used in embodiments of the present invention is similar to that of IPv6. A packet consists of a packet header, 0 or more extension areas, and a data area. The type of each area is indicated by the header of the preceding area. An extension area consists of 3 fields: the option type of the next area, the length of the data, and the data. The data area is identical except that the option type of the next area is always 0 because it is the last area in the packet. In the preferred embodiment, extension areas are generally implemented as described in IPv6, although only the destination option area, authentication option area and encapsulating security payload option area, which are all specified in IPv6, are actually used. The preferred embodiment includes two additional option types: an invoicing option and a marked-out road option.

In other embodiments of the present invention, the invoicing option area is used to accumulate the cost of transport for a packet as the packet travels through the network. Its data consists of the operator number of the carrier to be charged and fields to accumulate the costs of transport. As a packet moves along a path in the network, cost information is added to the invoicing option area so that the proper carrier account can be charged.

As further explained in greater detail below, the marked out road option used in embodiments of the present invention gives advice to the routing system. A network may have certain well-known backbone nodes between regions or between subregions. By recording a sequence of relay nodes in the option area, a node can direct a packet towards a backbone. This allows for more consistent routing and better utilization of high-volume backbones.

In order to reduce the number of acknowledgments that need to be sent, embodiments of the present invention pack multiple packets into frames. A node sends a frame, rather than an individual packet, to an adjacent node. The lowest level of the protocol, the frame layer, concerns itself with sending and receiving frames. The packing and unpacking of frames is done in the multi-packet layer.

Each node in the network runs the same protocol stack that is concerned with point-to-point transfer. This stack consists of three layers: the frame layer, the multi-packet layer, and the packet layer. The frame layer handles the sending and receiving of frames. The multi-packet layer is responsible for unpacking and packing frames. The packet layer treats each packet according to its type and determines the next node in the packet's path. All three layers perform congestion control functions and interact with the routing module. End user nodes also run several additional layers that are responsible for setting up end-to-end connections, packetizing, etc.

Referring again to FIG. 1A, data enters and exits the network 100 through a HAP 110. In one embodiment of the invention, each HAP 110 is able to connect to 30,000 or more independent devices. A HAP 110 acts as a portal to the network 0100, and in addition to having routing functions a HAP 110 can perform other management functions, such as requiring a user to pay for access to a movie.

Possible types of data sources include a multicast stream 120, a real-time full-duplex stream 130, and a file server 140. A multicast stream could be sent to specialized receivers 160 or a personal computer 150. A personal computer 150 might download files from a file server 140.

Turning to FIG. 1B, examples of possible exemplary devices connected to the network 100 are depicted. For example A video source 125 is connected to a HAP 110 and sends video to a desktop computer 155 and a television 165 which are both connected to a HAP 110. Telephones 135 are connected to a HAP 110 and can be used for a real-time conversation. A web server 145 is connected to a HAP, as is a local area network (LAN) 158. One of ordinary skill in the art would understand that other embodiments of connected devices are also possible.

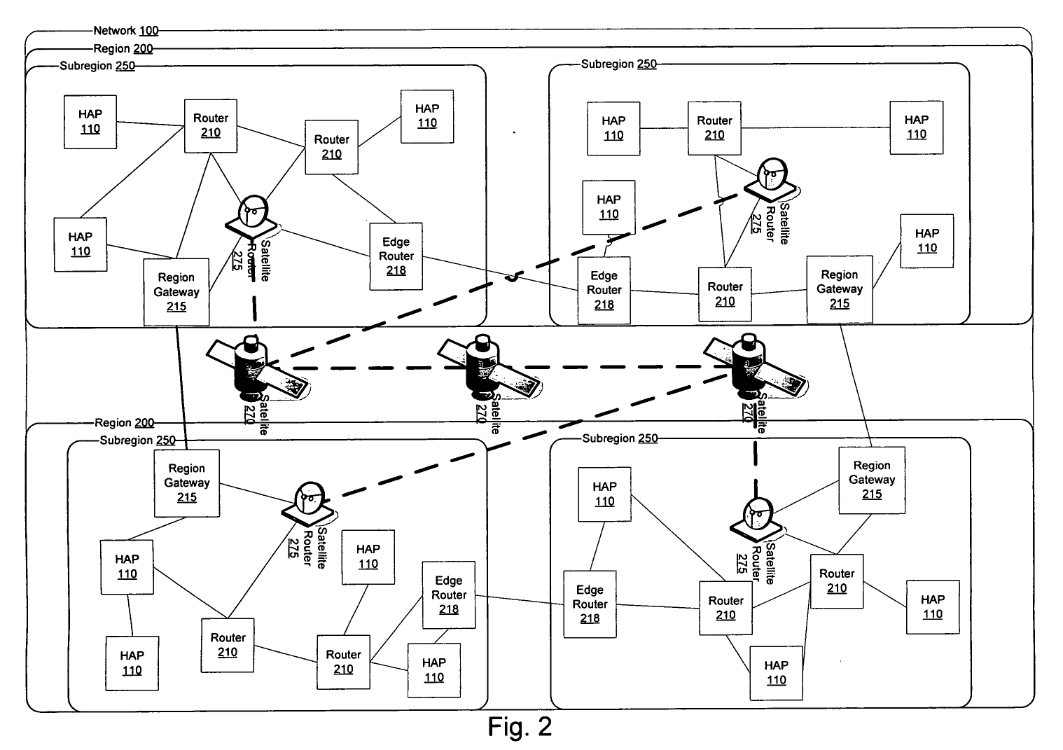

FIG. 2 illustrates the geography of the network 100. The entire network 100 is subdivided into regions 200. In the preferred embodiment, a region 200 would be a country. A region 200 is divided into subregions 250. The number of subregions in a region is not fixed, and can be set as necessary to improve routing performance. Within a subregion, HAPs 110 are placed in order to allow local users to connect to the network 100 through a HAP 110. Regions 200 are connected directly through region gateways 215. A region 200 also may have a satellite router 275 that has a permanent link to a satellite 270. Thus, regions 200 can connect to another region either through a region gateway 215 or a satellite link. A satellite router 275 is a specialized type of region gateway 215. Subregions 250 connect to subregions 250 within the same region 200 through edge routers 218. Within a subregion 250, there are also routers 210 that route within the subregion 250 only. Routers 210, HAPs 110, satellite routers 275, region gateways 215, and edge routers 218 all run the same network protocols and use the same addressing scheme, although specialized nodes, like satellite routers 275, have additional functionality as necessary.

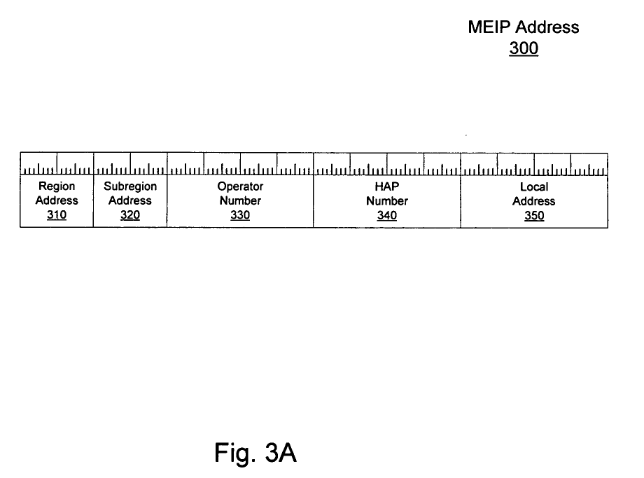

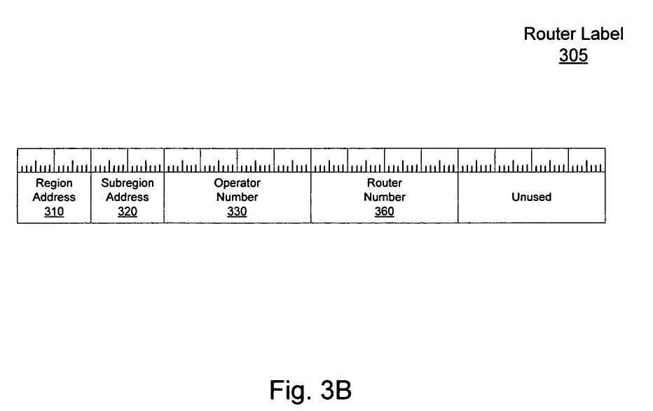

Turning now to FIG. 3A, embodiments of the present invention use a Multicast Evolution IP (MEIP) address 300 that uniquely identifies a user device connected to the network 100. In the preferred embodiment, MEIP addresses 300 are 128 bits long to allow compatibility with IPv6 addressing. An MEIP address 300 is hierarchical and consists of 5 fields: a region address 310, a subregion address 320, an operator number 330, a HAP address 340, and a local address 350. The region address 310 uniquely identifies a region 200 within the network 100. In the preferred embodiment, the region address 310 is 16 bits long, which allows for encoding by continent and then country. The subregion address 320 uniquely identifies a subregion 250 within a region. Note that two subregions 250 that are not within the same region 200 may have the same subregion address 320. In the preferred embodiment, the subregion address 320 is 16 bits long, which allows for flexible division of a country into geographical areas based on density of population or other concerns. The operator number 330 uniquely identifies the owner of the equipment, and is used for billing as well as to identify a HAP 110. In the preferred embodiment, the operator number 330 is 32 bits long. The HAP address 340 uniquely identifies a host access point 110 owned by a given telecommunications carrier. The operator number 330 combined with the HAP address 340 uniquely identifies any HAP 110 within a subregion 250. In the preferred embodiment, the HAP address 340 is 32 bits long. Lastly, the local address 350 uniquely identifies a device connected to a HAP 110. Local addresses 350 are only unique to one HAP 110—two devices connected to different HAPs 110 may share the same local address 350. In the preferred embodiment the local address 350 is 32 bits long. The application of the MEIP address 300 is described in greater detail below.

FIG. 3B shows the format of an exemplary router label 305 used in embodiments of the present invention. An router 305 uniquely identifies a node within the network 100. In the preferred embodiment, router labels 305 are 96 bits long, although 32 bits of empty space can pad the address if a field requires a 128 bit address. A router label 305 is hierarchical and consists of 4 fields: a region address 310, a subregion address 320, an operator number 330, and a router number 360. The router label 305 is padded with empty space so that it is the same length as an MEIP address 300. The router number 350 uniquely identifies a node owned by a given telecommunications carrier. The operator number 330 combined with the router number 350 uniquely identifies any node within a subregion 250. In the preferred embodiment, the router number 350 is 32 bits long.

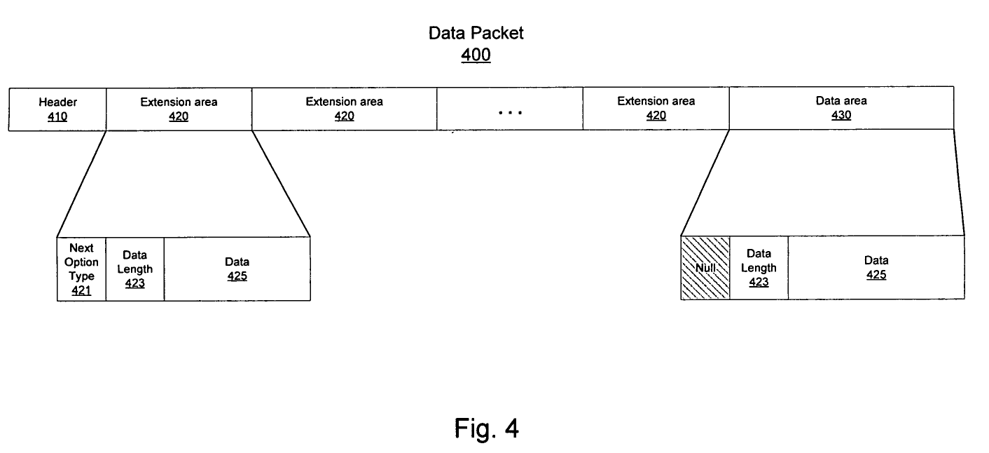

As described in greater detail below, the improved network 100 of the present invention relies on pack-based data transmission to disperse various types of data. Turning now to FIG. 4, the contents of an exemplary single data packet 400 used in the network 100 are depicted. A packet 400 typically consists of a header 410, optionally one or more extension areas 420, and a data area 430. The optional extension area 420 consists of 3 fields: the type of the next option 421, the length of the data 423, and the data itself 425. The header 410 also contains the type of the next area 421, so that the type of the first extension area 420 can be determined. The data area 430 also consists of 3 fields: a field the same length as the next option type 421 but set to 0, the length of the data 423, and the data itself 425. The general format of extension areas and the data area is the same, although the format of the data 425 is dependent upon the type of area.

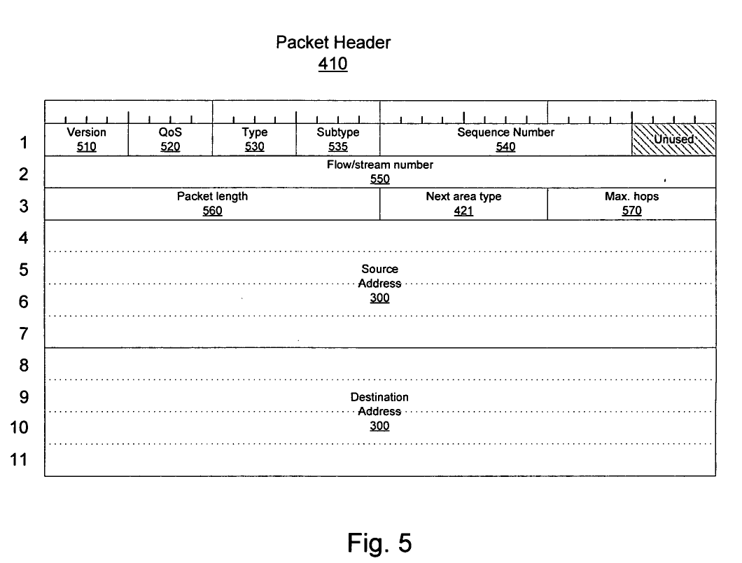

FIG. 5 illustrates a preferred embodiment of the packet header 410. In this preferred implementation, the packet header is eleven 32-bit words. Specifically, the packet header consists of the following fields: protocol version 510; quality of service type (QoS) 520; packet type 530; packet subtype 535; packet sequence number 540; flow/stream number 550; packet length 560; next option type 421; the maximum number of hops for this packet 570; the MEIP address 300 of the source; and, the MEIP address 300 of the destination. The version 510 is hard-coded depending on the protocol version being used. In the preferred embodiment, the protocol version 510 is 4 bits long. The QoS 520 determines the priority of treatment of the packet. A lower value for QoS 520 corresponds to higher priority and pushes the packet towards the front of the input queue. In the preferred embodiment, the QoS 520 is 4 bits long and optionally takes one of 6 values as depicted in Table 1:

TABLE 1

| QoS type | QoS value |
|---|---|
| System | 0 |
| Real-time | 1 |
| Live-stream | 2 |
| High priority | 3 |
| Normal priority | 5 |
| Low priority | 6 |

The purposes for the QoS types 520 are discussed in greater detail below.

Continuing with FIG. 5, the packet type 530 specifies the kind of treatment a packet should receive, e.g., live video stream, telephone call, etc. because the network 100 of the present invention enables different treatment of different data types, as described in greater detail below. In the preferred embodiment, the packet type is 4 bits long, and takes one of 5 types, as depicted in Table 2:

TABLE 2

| Packet type | Packet type value |
|---|---|
| System query | 1 |
| Telephone | 2 |
| Multi-cast | 4 |
| Message | 6 |
| Data flow | 8 |

Certain types of packets may be restricted to certain QoS values. In the preferred embodiment, the following combinations are allowed as depicted in Table 3:

TABLE 3

| | Allowed | Packet |
|---|---|---|
| Packet | QoS | type |
| type | value | value |
| System | 0 | 1 |
| query | | |
| Telephone | 1 | 2 |
| Multi-cast | 2 | 4 |
| Message | 3, 5, 6 | 6 |
| Data flow | 3, 5, 6 | 8 |

The purpose of the packet subtype 535 is dependent upon the packet type 530. A common usage is to use the subtype 535 to mark a packet as a router packet. When a node receives a router packet, the node knows that no path currently exists for this packet and the other packets in the same flow or stream. The routing algorithm can act accordingly. Another common usage of the subtype 535 is to mark a packet as the last packet in a stream or flow. In the preferred embodiment, the packet subtype is 4 bits long. The packet sequence number 540 is used for packets in streams or flows. The sequence number 540 is used by higher-level protocols in order to reassemble packets into the proper sequence and to detect missing packets. In the preferred embodiment, the packet sequence number 540 is 12 bits long.

The flow/stream number 550 is used to identify the corresponding flow or stream for this packet. Each data flow or stream is assigned a unique number so that all packets in the same flow or stream are routed the same way, if network conditions allow. This unique number may be assigned using known techniques, such as identifiers allocation algorithms used in IPv6. In the preferred embodiment, the flow/stream number 550 is 36 bits long. The packet length 560 is the length of the entire packet, including the header, in bytes. In the preferred embodiment, the packet length 560 is 16 bits long.

Continuing with FIG. 5, the next option type 421 indicates the type of the first extension area 420 following the packet header 410. If there are no extension areas in the packet, the next option type 421 will indicate that the data area 430 follows the packet header. In the preferred embodiment, the next option type 421 is 8 bits long. The maximum number of hops 570 is a limit on the number of nodes a packet may visit before reaching its destination. At each node, the maximum number of hops 570 is decreased by 1. If the maximum number of hops 570 reaches 0, the packet is discarded. In the preferred embodiment, the maximum number of hops 570 is 8 bits long.

Continuing with FIG. 5, the source address 300 and destination address 300 are the MEIP addresses of the source and destination devices, respectively. In the preferred embodiment, each address 300 is 128 bits long, as described above, to preserve compatibility with IPv6.

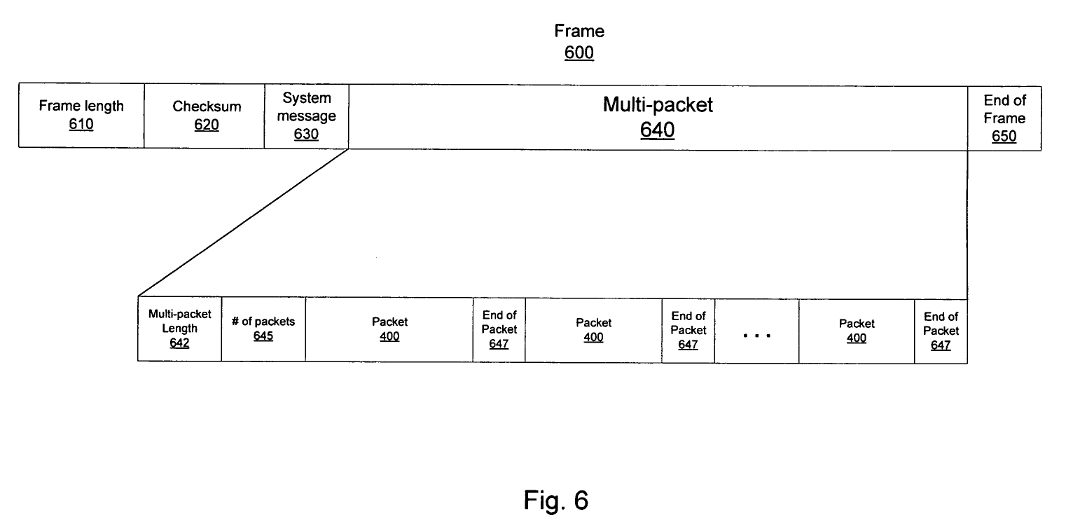

Turning now to FIG. 6, a frame 600 used in embodiments of the present invention is disclosed. The frame 600 generally contains 5 fields: the frame length 610, a checksum 620, a system message flag 630, a multi-packet 640, and an end-of-frame marker 650. The frame length 610 is the length of the entire frame 600 in bytes. The checksum 620 is a standard error checksum to verify that the contents of the frame 600 are error-free. The system message flag 630, if set, indicates that the frame 600 should be processed by the frame layer. System messages include the exchange of routing tables, congestion status from adjacent nodes, and acknowledgments. The multi-packet 640 is essentially 1 or more packets 400 concatenated. The multi-packet 640 begins with the multi-packet length 642, which indicates the length of the entire multi-packet in bytes, the number of packets 645, which indicates the number of packets in the multi-packet, followed by a sequence of packets 400. After each packet 400 is an end-of-packet marker 647, which is a unique string of bits indicating the end a packet. The end-of-frame marker 650 is a unique string of bits that indicates the end of a frame 600.

Applications of MEIP address 300, the router label 305, the data packet 400, the frame 600, and the multi-packet 640 of FIGS. 3A-3B and 4-6 are now described.

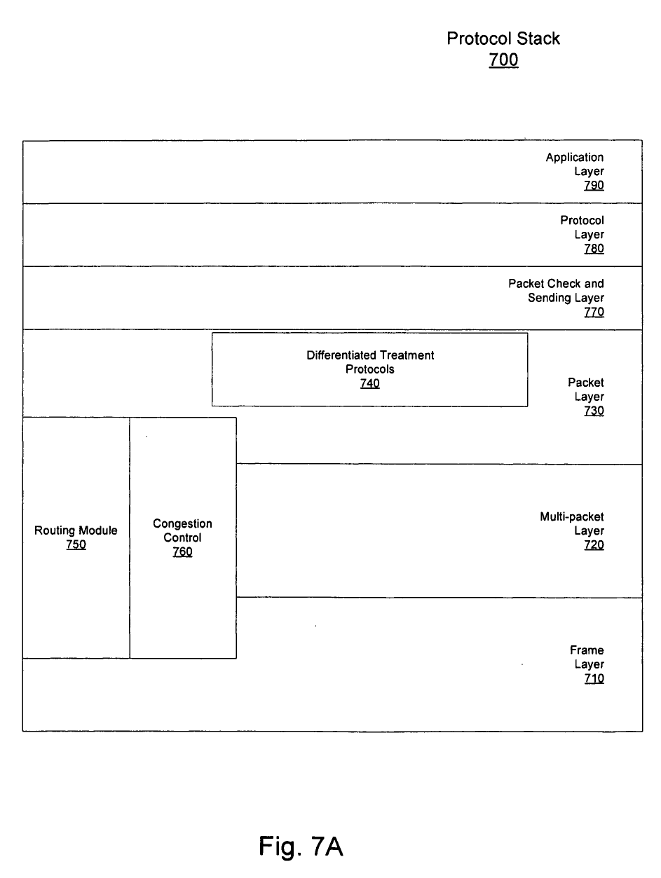

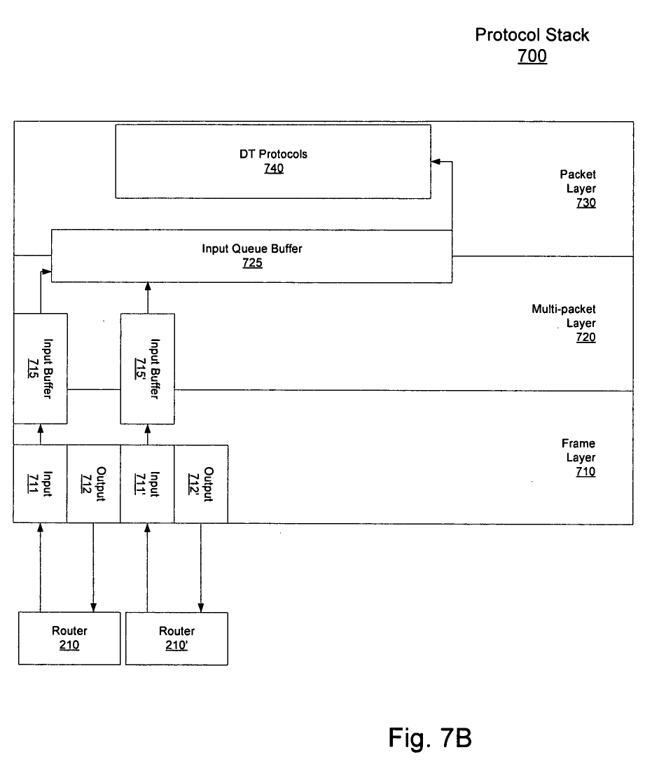

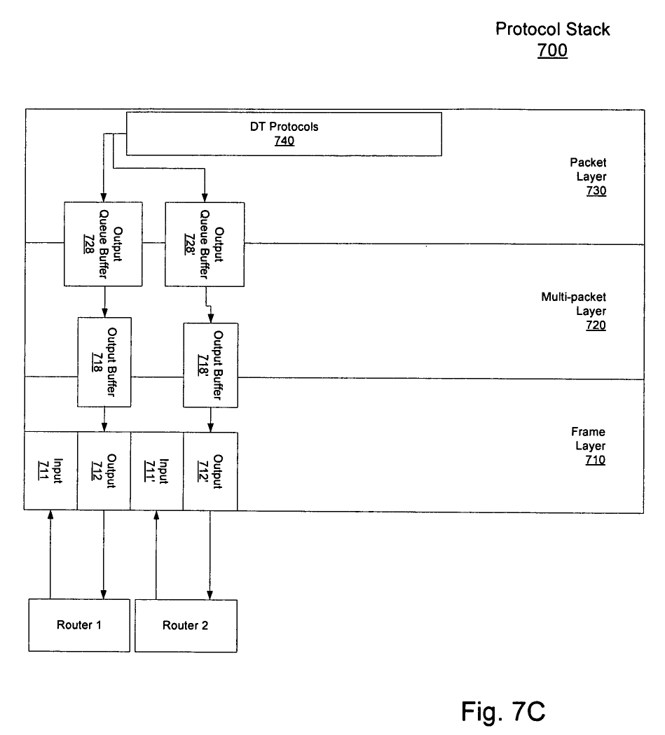

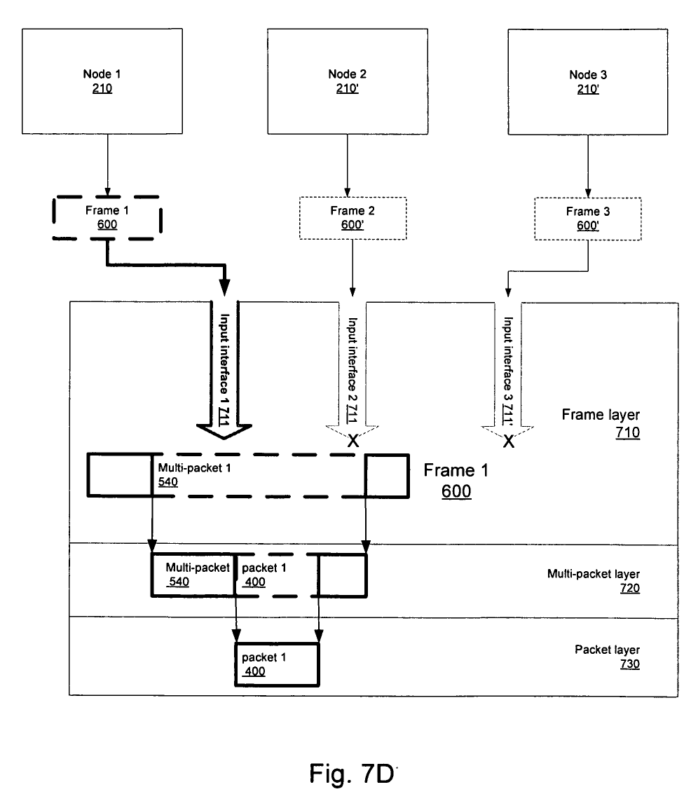

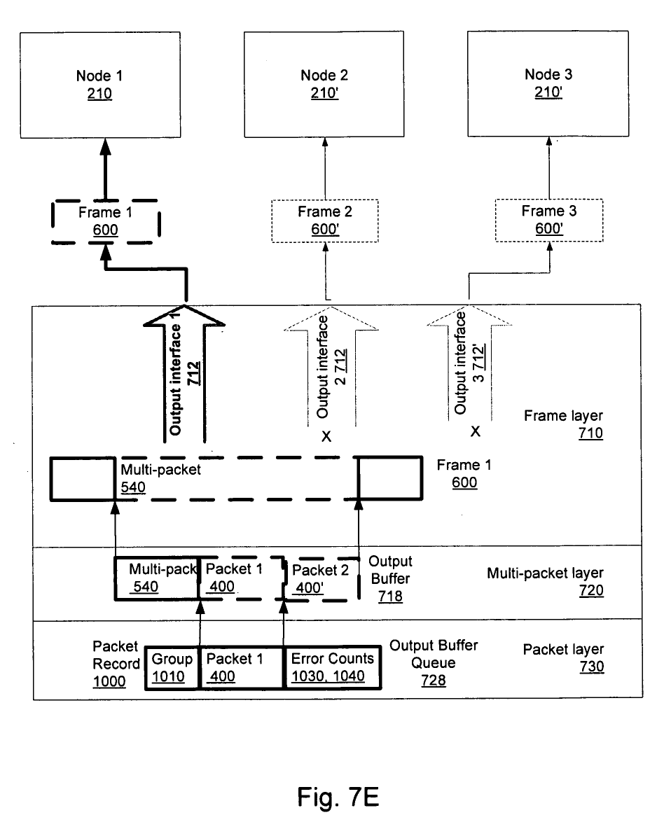

In FIG. 7A, the layers of the protocol stack 700 that run on a node in accordance with embodiments of the present invention. The protocol stack 700 consists of six hierarchical layers: the frame layer 710, the multi-packet layer 720, and the packet layer 730, the packet checking and sending layer 770, the protocol layer 780 and the Application layer 790. Within the packet layer 730 are differentiated treatment (DT) protocols 740, where one protocol exists for each allowed packet type 530. The routing module 750 and congestion control system 760 are used by all three bottom layers 710, 720, 730. These layers 710, 720, 730, 770, 780, and 790 define the segmentation of a functions model. Each layer 710, 720, 730, 770, 780, and 790 is independent and represents an abstraction level which depends on the lower layer and provides its services to the upper layer, or vice versa.

The layers of the protocol used in the present invention differ from slightly from the TCP/IP protocol which itself is different from OSI model of the ISO. The layers are separated into two groups, where the three lower layers 710, 720, 730 are mainly used on the nodes, or point to point, and the higher three layers 770, 780, 790 whose activation depends on the end-users, or end-to-end. As described in the greater detail below, the protocol structure of the present invention allows the point-point circulation of several types of packets (requests or data flows, stream packets for live video and communication stream packets for the telephone, video telephony and teleconferencing), while managing multiple qualities of service.

Turning now to FIG. 7B, data travels through the protocol stack from the frame layer 710 up to the DT protocols 740. A frame 600 arrives from a router 210 on an input interface 711 in the frame layer 710. In the typical case, the multi-packet 640 contained in the frame 600 is placed in the input buffer 715 that corresponds to each of the interfaces 711. The multi-packet layer 720 unpacks the multi-packet 640 into packets 400 and places those in the single input queue buffer 725. The packet layer 700 removes packets 400 one at a time from the input queue buffer 725, and routes each packet 400 to the appropriate DT protocol 740 for the packet type 530 of the packet 400.

FIG. 7C shows how data travels from the DT protocols 740 to an output interface 712. The DT protocol 740 determines the correct output interface 712 for a packet 400. The packet layer 730 places the packet 400 in the output queue buffer 728 corresponding to the output interface 712. The multi-packet layer 720 takes a number of packets 400 from the output queue buffer 728 and puts them into a multi-packet 640, which is placed in the corresponding output buffer 718. The frame layer 710 takes the multi-packet 640 from output buffer 718 and packs it in a frame 600, which is sent on the appropriate output interface 712.

Referring now to FIG. 7D, the interaction of the frame layer 710 and the multi-packet layer 720 (orientation reversed from FIGS. 7A-7C) is described in greater detail. The function of the input frame layer 710 is to receive the frames that are sent to one of its multiple input interfaces 711 of a router, hereafter node, 210. The input frame layer 710 intervenes on the level of the physical communication connections and uses protocols in relation with the technology used to connect the nodes 210 to one another. It thus receives the bits in its interfaces through each communication channel and groups them into the frames 300. A node may have one more input interfaces 711, each of which is connected to another node 210. Typically, only one of the input interfaces 711 are active at any particularly time, such that an input interface 711a may be used to connect a first node 210a to receive a frame 600, while other input interfaces 711b, 711c are waiting to connect to their respective nodes 210b, 210c.

With an established connection between the input interface 711a and its node 210a, a frame 600 is transferred from that node 210a to the frame layer 710. In the frame layer 710, the frame 600 striped to extract the multi-pack 640 that is send to the multi-packet layer 720. Specifically, when a frame 600 has been delivered and checked, the multi-pack 640 is extracted, then deposited in an input buffer specific to each communication interface 711.

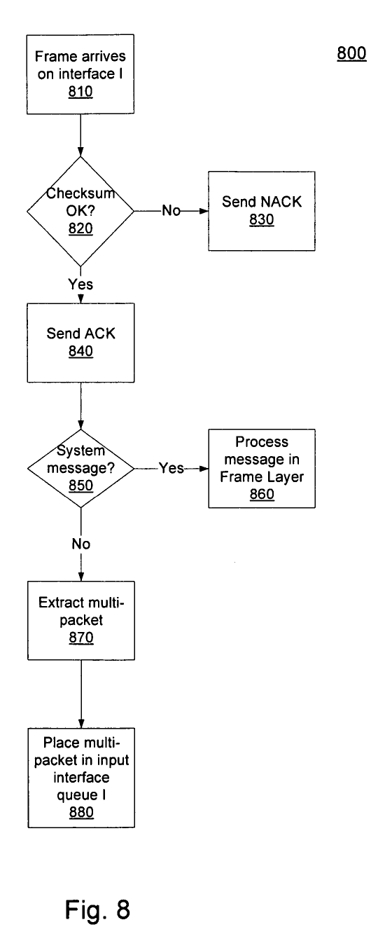

Referring now to FIG. 8, the process of checking each frame 600 received over a node interface 711 is described. The frame checking process 800 begins after a frame received in th4 input interface as described above, step 810. The frame is subjected to an integrity control in step 820 in order to check that the frame data has not been altered during the point to point transport. The integrity check 820 proceeds according to known techniques. If this check 820 reveals data problems, a NAK (negative acknowledgement) message is returned to the transmitting node in step 830 so that it can reissue the frame. If this check step 820 finds no problems, the multi-packet contained in the received frame is extracted and, according to the contents standard code data, the datagram is either only taken into account by the frame layer or pushed in the interface input buffer, which means that it is placed at the disposal of the multi-packets layer, as described above in FIG. 7D. In step 840, a message ACK (acknowledgement) of the physical protocol is returned to the transmitting node to tell it to send the following frame.

As explained above, each input buffer can generally contain only one multi-packet. Before extracting the multi-packet, step 870, and putting the extracted multi-packet in the interface input buffer in step 880, the protocols makes sure in step 850 that the buffer is really free, i.e. the preceding datagram has really been processed by the multi-packets layer 720. If not, a waiting temporization may be initiated to allow the processing in the frame layer 710, step 860. The ACK message put on standby until the buffer is released, thus creating a stream control over the interface 711.

As depicted in FIG. 7D, the first function of the input multi-packet layer 720 is to handle the multi-packet 640 pushed by the frame layer 710 in the input interfaces buffers 711. Specifically, the multi-packet layer 720 extracts, one by one, each of the packets 400 contained in each multi-packet 640, then individually writes them in a buffer called input queue 731, common to all the input interfaces 711, from which the packets 400 are treated one by one by the packets layer 730. For example, the packets 400 may be written in the input queue buffer according to a classification based on a double code (a packet group code and a QoS code for each packet), as described above in Table 3. For example, a value of “1” is allotted to the packet group code, to all the packets resulting from an input multi-packet.

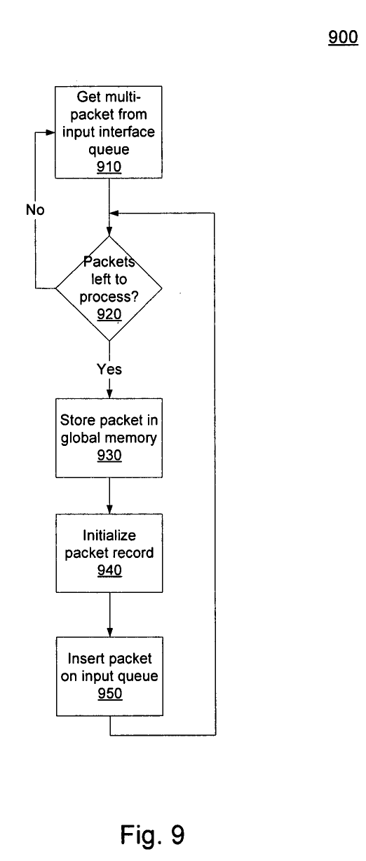

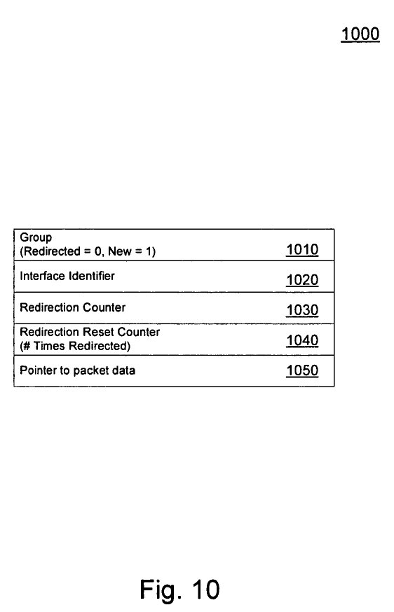

This multi-packet handling process 900 is described in FIG. 9. To carry out the task of handle the multi-packet 640 in process multi-packet handling process 900, the multi-packets layer 720 has an automatic mechanism which analyzes the interface input buffers associated with the input interfaces 711, to see when they contain a new multi-packet 640, step 910. In such a case, the multi-packet layer 720 analyzes the multi-packet 640 in the input buffer to determine if any packets 400 remain unprocessed, step 920. If any packets 400 remain, the multi-packet layer 720 acquires and stores the packet, step 930. The packet record, described in greater detail below in FIG. 10, is initialized in step 940 and the packet is inserted into the input queue for use by the packet layer 730 in step 950. step 930-950 continue until no additional packets 400 remain in the multi-packet 640. At this point, the input buffer of the interface 711 is erased to allow the next multi-packet 640 of the interface 711 coming from the frame layer 710 in step 910, and the process 900 restarts.

As described above in FIG. 6, in the protocol stack 700 of the present invention, the multi-packet 640 contains one or more packets 600, where each multi-packet 640 includes a heading which specifies the multi-packet length 642 and the packets number 645. The remainder of the multi-packet is occupied by one or more packets 400, each of them ended with a flag 647.

Turning now to FIG. 10, after the packets 400 are received in the input queue buffers 725 in step 950, the packet layer 730 in one embodiment of the present invention appends additional pieces of information to a received packet 400 to form an internal packet record 1000 and moved to an output queue 718. For example, the internal packet record 1000 may contain a group number 1010 that indicates whether the packet is new (value of 0) or is redirected (value of 1), an interface identifier 1020 identifying the interface 711 through which the frame 600 containing the data in the packet 400 of a pointer to the packet data 400 entered the node, and two fields concerning a redirection alarm.

Continuing with FIG. 10, the redirection alarm may be composed of a counter 1030 which is set using known techniques according to a schedule time value and of a redirection time limit value that depends on the quality of service of the packet. The redirection alarm counter 1030 is accompanied by a sub-counter 1040 that notes the number of times the redirection alarm was set. As described in greater detail below, the value of the redirection alarm counter 1030 represents the deadline for re-examining the packet situation within the node 210 if the packet has not proceeded towards a distant node 210. For example, if the deadline of the redirection alarm counter 1030 has expired, the counter 130 is reset and some decisions are taken by the anti-congestion mechanism in order to try to choose another output interface for the packet. The resetting of the counter is noted in reset counter 1040. The packet situation can thus be re-analyzed multiple times, as recorded by the at the deadline of the redirection alarm counter 1030. A end of packet flag 1050 may then be added to the internal packet record 1000.

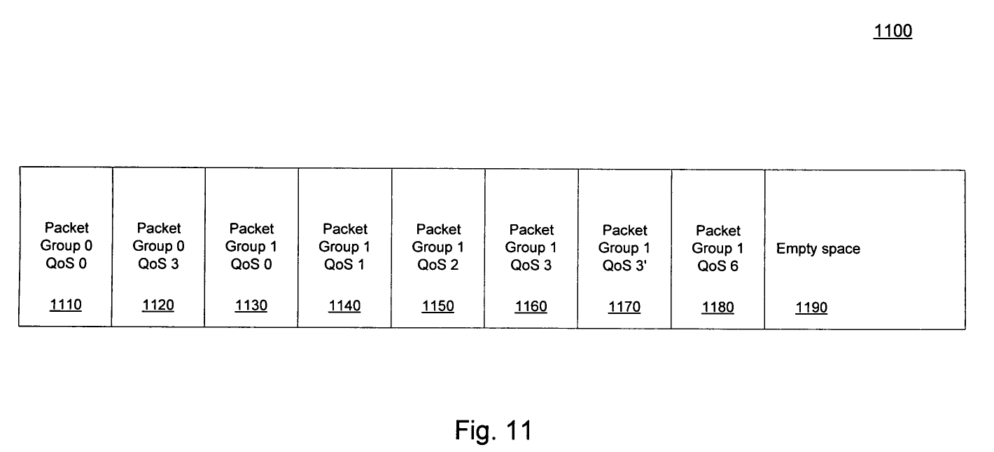

The internal packet record 1000 containing the packets 400 with the additional information 1010-1050 are grouped together in an out queue buffer 718 of the packet layer 730 according to the group number 1010. The exemplary output queue buffer 1100 of FIG. 11 has clustered packets 1110 and 1120 of group 0 and packets 1130-1170 of group 1. The internal packet record 1000 that have just entered the node 210 according to group code 1010 are then arranged according to their QoS code 520 such that the packets with the higher priority QoS codes (in this case, lower QoS values 520), such as packets 1130 and 1140, are placed first in the output queue buffer 1100 before the lower priority QoS, such as such as packets 1160-1180. Within the same QoS code 520, the packets 1160 and 1170 may be are arranged in order of arrival in the buffer, commonly known in computer science as first-in-first-out (FIFO) mode.

The packet ranking according to their QoS code within a same group code inside the input queue buffer means that the packets 400 whose QoS code have the highest priority will be processed first. For example, using the QoS designations defined in Table 1, packets of priority 5 or 6, such as packet 1180 are not processed there are no remaining packets 1130-1170 with a QoS priority level of 0, 1, 2 and 3. An end of packet queue flag 1190 then indicates to the packet layer that no further packet records 1000 remain in the input queue 1100.

It should be noted that organizing the packets in the output queue buffer 718 by group value 1010 allows the packet layer 730 prioritize packets that remain from a previous packet processing cycle, which in the present example are the packet records 1110 and 1120 having a group value 1010 equal to 0. As described in greater detail below, theses records 1110 and 1120 that have been treated in output queue buffers 718 of the packet layer 730 but did not exit the node during the processing cycle due to various reasons, are pushed back in the input queue buffer 1100 to undergo differentiated treatment again. In such a case, the group 0 packets 1110, 1120 are placed at the beginning of the input queue buffer 1100 before the new packets records 1130-1180 that have just entered the node with group code 1. Generally, the group 0 packets are in the minority in the input queue buffer.

Referring back to FIG. 7C, the multi-packet layer 720 has an important role in managing the output queue buffers 728 of the interfaces of a node. As described above, each output queue buffer 728 is used to store the departing packets in an output interface 712 of the node 210, which is connected to a remote node 210 through a telecommunication link. The packets 400 to be sent to a remote node 210 are extracted from the corresponding output queue buffer 728 and grouped in a multi-packet 640 in the output buffer 718 of the corresponding interface so that it is processed by the frame layer 710. The multi-packet layer 720 may continuously check the output interface buffers 708 in order to detect those emptied by the frame layer 710, and as soon as an output buffer 708 of an interface is found empty, the multi-packet layer 720 fetches the next packets 400 in the output queue buffer 728 corresponding to the empty buffer 718 to form a new output multi-packet 640 to be next push in the output buffer 708.

In this way, the output queue buffer 728 of an interface is asynchronously emptied as the frame layer 710 forwards packets to the output interface 708. Whenever a packet leaves the queue buffer 728, the remaining packets 400 are pushed towards the start of the buffer 728. Thus, the network protocol of the present invention allows communication between nodes to be carried out through frames 600 containing a multi-packet 640 of packets 400 to accelerate communication between two nodes.

Referring now to FIG. 7E, the multi-packets layer 720 takes the packets 400 from the output queue buffer 728, starting with the beginning of the buffer and removes the aspects of packet record 1000, described below in the FIG. 10 and the related text. For example, the multi-packets layer 720 may remove the group code 1010, the input interface number 1020 and the alarm redirection counter fields 1030, 1040. The packets 400 are then grouped at the multi-packet layer 1020, usually separated each by an end-of- packet flag 647 and preceded by a multi-packet header containing the length of the multi-packet 642 and the number of packets within the multi-packet 645.

As described in greater detail below, when the packets 400 are set into the multi-packets 640, the multi-packet layer 720 may optionally add the cost of transport of the packet in the node in an extension area 420 of each packet for invoicing. This cost is also be also registered by telecommunication common carrier in the node tables and dispatched for various statistics. The cost of the transport of a packet 400 through a node 210 may use a pre-defined formula that considers the type of the packet 530, the QoS code 520, and the quality of the route chosen to get out of the node.

Optionally, when the multi-packet is to be set, the multi-packet layer may test the status of the remote, intended recipient node 210 and the general status of the interface in order to predict whether some or all of the packets may be prevented from moving to the remote node because of congestion or break of the telecommunication link.

The number of packets in the multi-packet 640 from a node 210 is generally limited by what can be accepted by the remote node 210. In cases where the recipient node can only accept single packets 400, the multi-packet 640 may not be created.

The architecture of the multi-packet layer 720 depicted in FIG. 7C corresponds to a node with 2 output interfaces 712, each with its own corresponding output queue buffer 728 from which the packets are taken in order to make up the multi-packets that are pushed to the corresponding output buffer 718. It should be appreciated that the node may have any number of output interfaces 712, and preferably has at least six output interfaces 712, with a corresponding number of output queue buffers and output buffers. Also, it is further foreseeable that the network 100 of the present invention may be adapted such that the number of interfaces does not necessarily correspond to the number of output queue buffers and output buffers.

Continuing with FIG. 7C, the output portion of the frame layer 710 has the function of processing the multi-packets pushed in the output buffers 718 by the multi-packet layer 720 and to send the multi-packets in frames over the output interface 712 towards the desired remote node. The frame layer 710 plays a part in physical communication links and uses protocols corresponding to the technologies used to connect the nodes to one another. Before sending a multi-packet 640 in output buffer 618, the frame layer 710 transforms the multi-packet 640 into a frame 600 by adding specific data concerning its physical transport. As previously described in FIG. 6, this data may include a length frame field 610, an integrity control checksum 620, a data type code 530 and at the frame end, an end-of-frame flag code 650.

As described below in FIG. 8, when a frame 600 is sent over an output interface 712, the frame layer 710 waits to receive an acknowledgement message to acknowledge that the frame 600 was actually received at the remote node, then it will erase its output buffer to allow the multi-packet layer 720 to forward another multi-packet 640. If the remote node does not a acknowledge the frame transfer, the frame is re-issued over the interface through physical protocols.

Optionally, the frame layer 710 may check the performance of the output interfaces 712 using known techniques and then take the corresponding corrective steps, such as shutting down an interface 712 if the corresponding remote node does not respond correctly. As described in greater detail below in the discussion of the operation of the network 100, the frame layer 710 may purge the existing data in the routing tables, and then update the routing tables to reroute transmissions routed to pass through the faulty interface.

The second function of the multi-packet layer 720 is the redirection of packets in case of a transmission error. As described above, the multi-packet layer adds two counters 1030 and 1040 for the redirection alarm to each packet and to reset for the redirection alarm. The first counter 1030 defines the deadline, after which the situation of the packet will be examined if the packet has not been successfully transmitted to a remote node, and the second counter 1040 computes the number of times the first counter is was reset. The second counter 1040 is generally capped to limit the number of transmission attempts. For example, the error reset counter 1040 may be programmed to not exceed four.

In embodiments of the present invention, the multi-packet layer 720 is in charge of controlling the redirection alarm counter 1030 for all the packets records 1000 in all the output queue buffers 728. As described below be way of the example, the multi-packet layer 720 may use an anti-congestion mechanism called a redirection mechanism to sequentially and permanently examine the content of the output queue buffers 728, packet by packet. This packet analysis may include the control of a redirection time-limit. If the time-limit is reached, the packet has not left the node quickly enough, probably because of congestion. In such a case, the redirection mechanism resets the redirection alarm counter 1030, increases by 1 the redirection alarm sub-counter 1040, withdraws the packet from the output queue buffer and relocates it at the beginning of the input queue buffer (by forcing its group code to zero) as depicted in output buffer 1100.

In this way, the packet is quickly reprocessed by the input packet layer to allow a new output interface to be chosen in order to allow the packet to rapidly leave the node. Optionally, the differentiated treatment protocols of the packet layer 730 will take into account the redirection alarm sub-counter 1030 to choose an output interface which is less congested.

When the redirection mechanism notes that the redirection alarm counter 1030 has expired, the redirection alarm sub-counter 1040 is examined before resetting the alarm counter 1030 and relocating the packet 400 in the input queue buffer 728.

For example, if the redirection alarm sub-counter 1040 reaches four, the packet has attempted four times to get out through a different interface without success. This may mean that there is a major congestion problem within the node, and the packet will be destroyed and the access to the node will be temporarily closed.

As described below, the redirection mechanism of the multi-packet layer 720 functions to avoid the congestion of the interface output queue buffers.

When an output interface 712 is selected for a packet by the differentiated treatment protocol, the congestion state of the output queue buffer 728 of the chosen interface 718 and the congestion state of the corresponding remote node 210 are taken into account. However, as the packet is likely to remain within the buffer before it is sent or before its redirection deadline, the redirection mechanism may continue to check the evolution of status of each remote node. If the status of the remote node changes and some access to this remote node is prevented, the redirection mechanism may check to determine lost access concerns the standby packets 400 in the corresponding output queue buffer 728. If so, the redirection mechanism will take the decision to get the packet and push them back in the input queue buffer 728 so that a new output interface 712 is chosen for these packets and the redirection counters may be reset if not yet due.

The redirection mechanism also checks the status flag of each interface. If faulty status flags for connections to a remote host 201 are activated, the link with the remote node may be been interrupted temporarily or definitively. In that a case, the packets waiting in the corresponding output queue buffer will never be able to move towards the remote node.

The multi-packet layer will then extract from the output queue buffer the packets one by one and will relocate them at the beginning of the input queue buffer so that they processed again by the packet layer, in order to allow a new interface to be chosen by the differentiated treatment protocols. This redirection mechanism will allow the progressive decongestion of the buffers in an important packet input stream. The mechanism may also reallocate the load over other interfaces using other node outgoing paths even if they are longer.

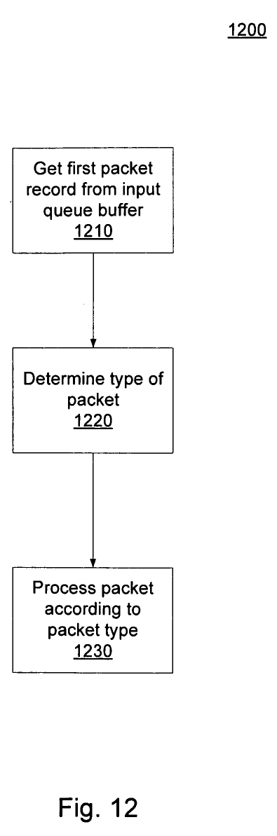

Referring now to FIG. 12, the packet processing method 1200 implemented by the packet layer 730 to handle the packets records 1000 in the input queue 1100 is now described. The packet layer 730 acquires the packet record from the input queue 1100 in step 1210 according to the above-described ordering of the packets records 1000 according to group type value 1010 and QoS setting 520. After acquiring the packet 400 in the packet record, the packet layer 730 determines the packet type in step 1220, typically defined by the packet type value 530 in the packet header 510. Examples of packet types values 530 were described above in Table 2. The packet layer 730 then processes the packet 400 in step 1230 according packet type determined in step 1220, as described below.

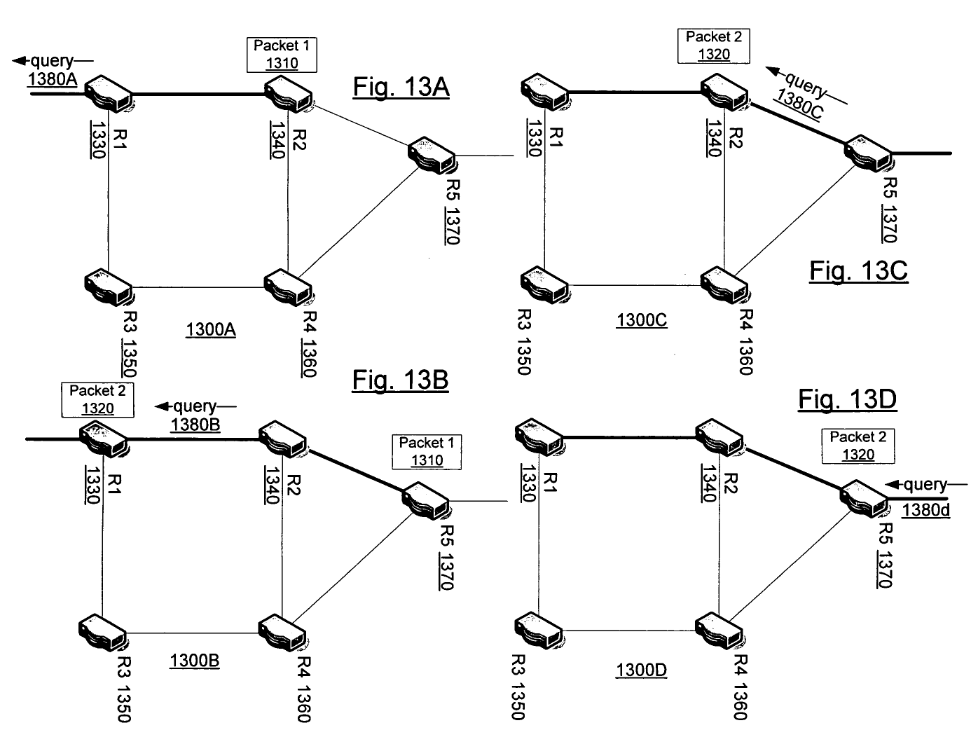

As presented above in Table 3, embodiments of the present invention may generally associate different packet types 530 with different associated QoS values 520. Referring back to Table 3, one of the packet types value 530 is a data flow, designated by a packet types value 530 of 8. As defined in Table 3, a data flow data type 8 is a sequence of data packets that generally uses a lower QoS than telephone packet type 1 or multicast packet type 2. A single data flow usually represents an object being transferred, like a data file, broken into a sequence of data packets 400. In embodiments of the present invention, flow control is typically achieved through holding the next packet in a sequence until a backward query is received from the next node in the path. This is illustrated in the example in FIGS. 13A-13D. The data flow in FIGS. 13A-13D consists of two packets 1310 and 1320 being transferred in a network including nodes R1, R2, R3, R4, and R5, respectively, nodes 1330-1370.

In network configuration 1300A of FIG. 13A, Packet 1 1310 is at node R2, having previously come from Node R1. Consequently, the Node R1 1310 currently has no packet in that data flow, and sends a backward query 1380A to a previous node in the path to request the next packet in the flow, Packet 1 1320.

In network configuration 1300B of FIG. 13B, node R2 1340 detects that it must find a route for Packet 1 1310 because Packet 1 1310 is the router packet, or the first packet in the data flow. A router packet has a flag, such as an initial sequence number 540 in the packet header 410, set to indicate that a new path must be created at each node in a data path for the packet-to-packet transfer between the two end nodes. The routing module implemented by DT protocol of the Node R2 1350 determines that the next node in the direct path should be node R5 1370. Packet 1 1310 is sent to the node R5 1370, which sets up a record for the data flow. The Packet 2 1320 arrives at node R1 1330 in response to the backward query it sent in network configuration 1300A. Node R2 1340, which now has no packet in the data flow, sends a backward query 1380B to node R1 1330, requesting the next packet in the flow.

In network configuration 1300C of FIG. 13C, node R5 1370 has sent Packet 1 1310 to the next, downstream node in the path (not illustrated), which was determined by a routing module in the DT protocols of node R5 1370. At the same time, node R5 1370 sends a backward query 1380C to node R2 1340 requesting the next packet 1320. In network configuration 1300C, the node R1 1330 sends Packet 2 1320 to node R2 1340 in response to its previous query 1380B. In the example, Packet 2 1320 is the last packet in the data flow, so node R1 1330 does not send a backward query requesting another packet.

In network configuration 1300D of FIG. 13D, node R2 1340 has sent Packet 2 1320 to node R5 1370 in response to the query 1380C. An outside node, not depicted, that had previously received packet 1 1310 may forward a query 1380D requesting transfer of the Packet 2 1320 in the next cycle. Because Packet 2 1320 is the last packet in the data flow, node R2 1340 does not send a backward query to node R1 1330. The last packet 1320 may have a flag, such as an indication in the sequence number 540 in the packet header 410.

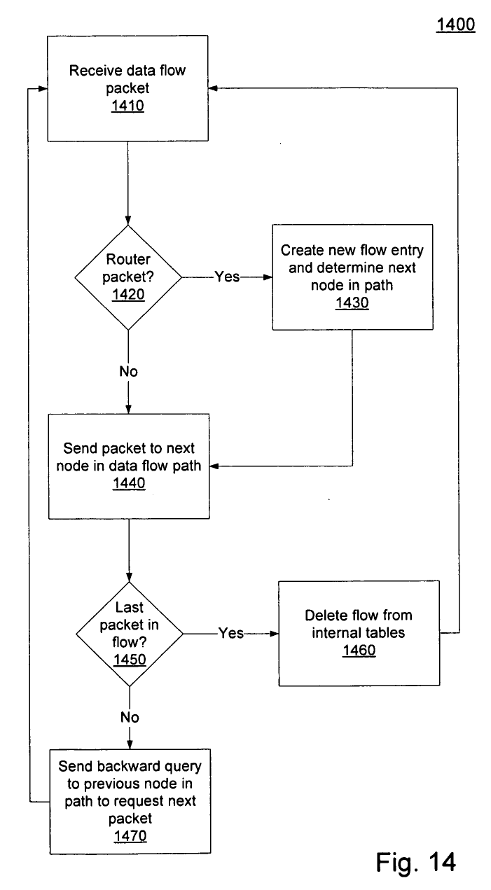

The data flow process 1400 is summarized in FIG. 14. A node first receives a data flow packet in step 1410. The node then checks the data flow packet to determine whether the received data flow packet is the router packet, step 1420. If so, the node created a new flow entry in the nodes internal memory records and determines the next node in the path, step 1430. The data flow packet is then sent to the next node in step 1440. The next node was either defined in step 1430 or was previously defined for the original router packet in the data flow. The node then examiners the records of the transmitted data flow packet to determine whether it was the last data flow packet in the data flow, step 1450. If the transmitted data flow packet was the last packet in the data flow, the node can remove the data flow path records from the internal tables, step 1460. Otherwise, the node returns a backwards query to the previous node in the path, as stored in the data flow path records from the internal tables, to request the next packet in the data flow, step 1470.

Embodiments of the network 100 of the present invention enable multicast live video (MLV), identified by a specific packet type (MLV packets) circulating on the network 100 to trigger a different treatment of point-to-point data transfers in the transit nodes. The purpose of the MLV system is to broadcast television through the network in a simple way at minimum cost, without saturating the nodes and the network bandwidth. It will use a breadcrumb trail principle for distributing the packets in order to avoid that parallel streams be sent to every online user connected to the computer source. The multicast is based on a unique source broadcasting a unique permanent and regular video stream, in packet format, containing a sequence of compressed images. To accomplish proper recreation of the original transmission, the transferred packets must follow one another within a limited time slice to ensure the required quality and regularity level to the broadcasting.

Referring back to Table 2, the MLV packet may circulate over the network with “live stream” quality of service, which is immediately inferior to that of telephone or video-telephony streams but superior to general data flows.

A defining characteristic of the MLV stream packets is that these packets do not contain any receiver address. Consequently, neither the computer transmitting the MLV packets nor the nodes do know the stream receiver or receivers and they do not have to manage tables of receivers or have this tables managed in order to distribute the stream, as it used to be the case with the IPv6 Multicast system.

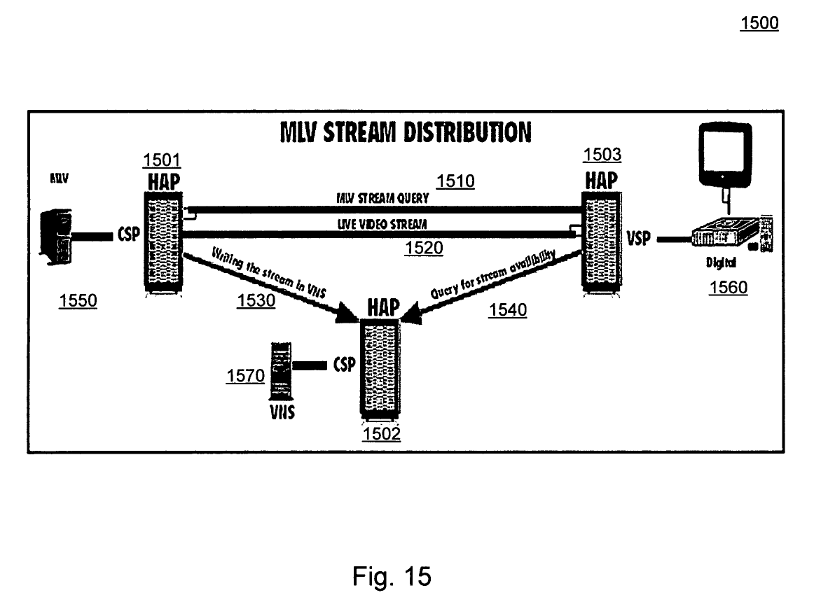

Referring now to FIG. 15, in the MLV system 1500 of the present invention, a telecommunication common carrier access point computer, or first HAP 1501, will be the official stream distributor for the system 1500 and to deliver the breadcrumb trail packet stream to the whole network. The first HAP 1501 is usually being fed by a video server of a final contents provider.

A second HAP 1502 coordinates the distribution of various MLS streams with a national server called VNS (video name server) 1570 which stores the list of streams, mainly the television channels, running at any point in time for a given network or area with correspondence between the stream name, the stream label, the server address, as well as various other information in stream 1530. The VNS 1570 is updated when broadcasting of a stream ends, and the VNS 1570 can be consulted by a video service provider (VSP) 1503 on behalf of its customers in query 1540 so that the customers can determine the ongoing broadcast streams and the conditions of access to these streams.

In the network 100 of the present invention, user may generally cannot directly access a live stream 1520 from his workstation or his network computer. Instead, the user passes a stream query 1510 through a VSP 1503, which that is entitled to control the access and distribution of a desired stream. The VSP (video service provider) is a specialized processor within a third HAP 1503, used for connecting a subscriber DIGITAL PLAYER 1560. IR should be noted that the MLV system 1500 operates through the control protocols of the network 100, and generally it is not possible to have MLV packets circulate within the network 100 without following the MLV system inner procedures.

In order to send a MLV stream, it is necessary to have a server 1550 using a specialized communication protocol for communicating with the corresponding first HAP 1501 that will broadcast the stream. The stream delivered through this server will meet the MLV standard, which may be defined using known techniques. Usually, only the second HAP 1502 may to access the secured VNS servers and to write the broadcast stream references together with its access conditions. At the other end, the end user will not be able to access a stream without going through its VSP 1503, and a user typically cannot receive the MLV stream packets without going through a VSP 1503. Similarly, a contents provider usually cannot directly send MLV packets over the network without having them intercepted and destroyed within protocol layers 700 of the modes controlling the data emission and the access to the network 100.

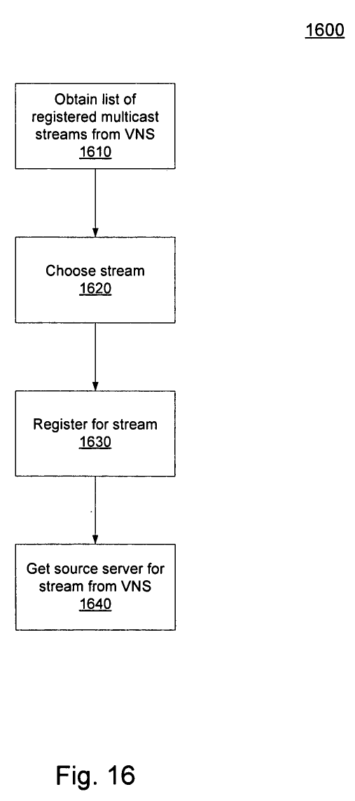

Instead, as depicted in Stream acquisition method 1600 in FIG. 16, the user generally first obtains a list of registered multicast streams from the VNS, typically through an inquiry 1540 in step 1610. Upon receiving the listing, the user choose a stream in step 1620 by forwarding a stream request (not depicted) and registering for the stream in step 1630, usually through the VSP 1503. The user can then determine from the VNS 1570 a source server 1501 in step 1640 to access the stream 1520 through the VSP 1503

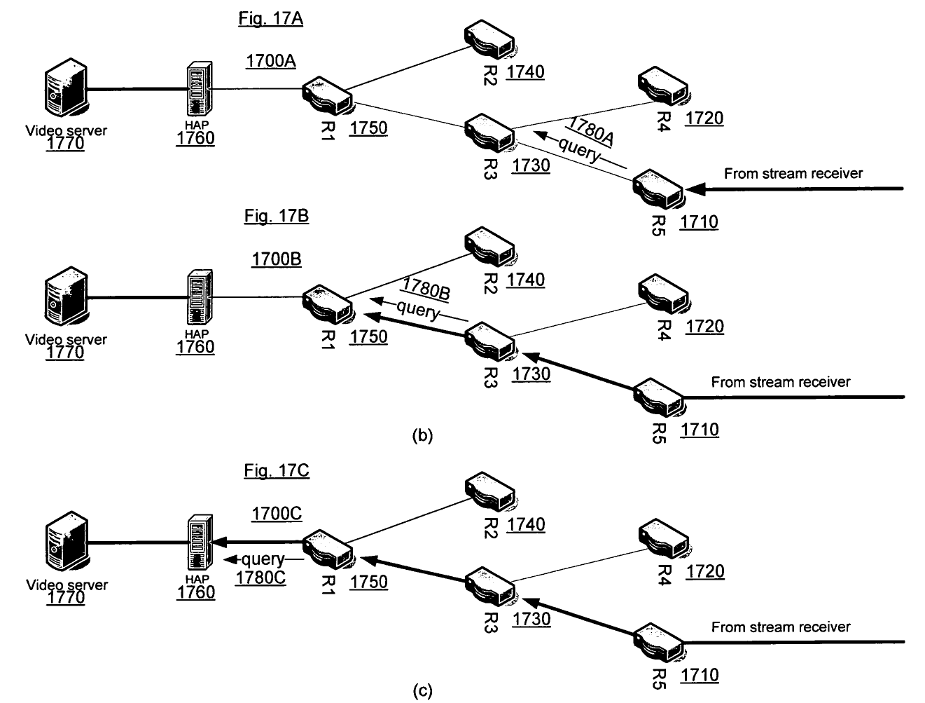

The path for a multicast stream is constructed backwards, working from the receiver to the source, as illustrated in the example in FIGS. 17A-17C. As described in greater detail below, once the origin of the stream has been discovered from the VNS, and any access terms have been satisfied, the receiver sends a multicast stream query packet out. In the typical case, each node receiving the query packet will add itself to the path for the multicast and note that a copy of the stream must be sent out along the incoming interface of the query packet.

In the MLS network 1700A in FIG. 17A, a multicast query packet arrives at node R5 1710. R5 1710 adds itself to the path for the multicast stream. Its routing algorithm identifies node R3 1730 as the next node to use to reach the video server, and node R5 1710 sends the query packet 1780A to node R3 1730.

In the MLS network 1700B in FIG. 17B, the multicast query packet has arrived at node R3 1730. Node R3 1730 adds itself to the path for the multicast stream. Node R3 1730 will record that when a packet for the stream arrives, a copy must be sent to node R5 1710. The routing algorithm identifies node R1 1750 as the next node to use to reach the video server, and Node R3 1730 sends the query packet to R1.

In the MLS network 1700C in FIG. 17C, the multicast query packet has arrived at node R1 1750. The node R1 1750 is already part of the path for the multicast stream, and node R1 1750 records that when a packet for the stream arrives, copies must be sent to both node R5 1710 and node R3 1730, but not to nodes R2 and r4, respectively 1720 and 1740. The query packet is discarded, and the path from the video server 1770 through the HAP 1760 is complete.

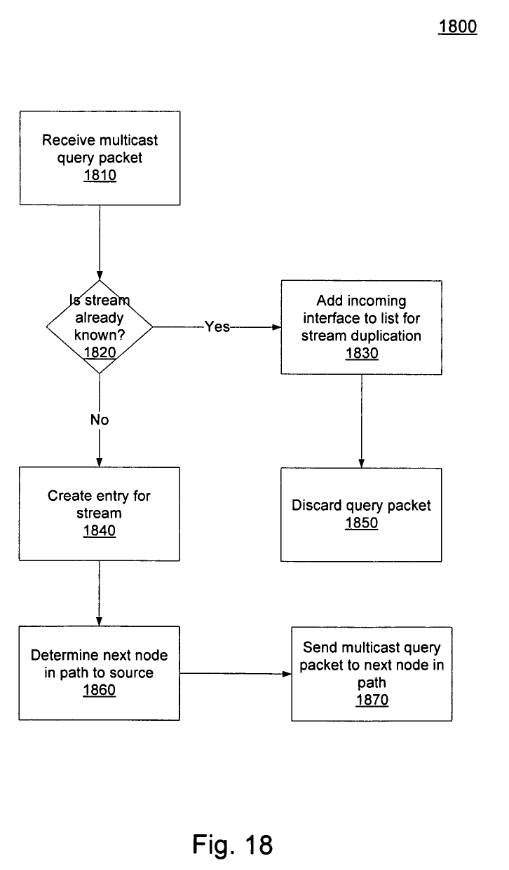

Thus, the present invention provides a multicast video transmission method 1800 depicted in FIG. 18. A node receives a multicast query packet in step 1810. The query includes an incoming interface identifying the requester of the stream. If the requested stream as already known, i.e., the recipient is already receiving the stream, step 1820, The node receiving the query adds the incoming path or interface to the list for stream duplication, step 1830, and discards the query, step 1850. Otherwise, there the query recipient creates an entry for the stream, step 1840, determines the next node in the path to the source according to a predefined algorithm in step 1860, and sends the multicast query packet to that next node in step 1870.

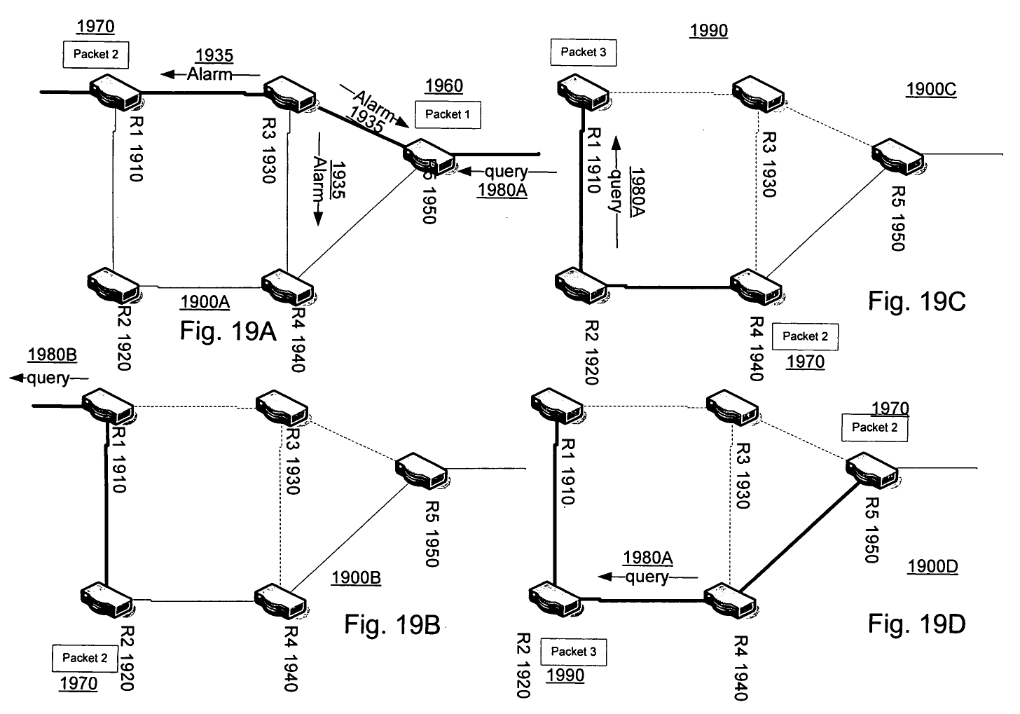

Embodiments of the present invention provide for robust congestion handling. For example, return to the node example provided in FIGS. 19A-19D, the invention automatically reroutes packets when congestion or other problems is detected in the network. FIG. 19A illustrates an example of a data flow state 1900A interrupted by congestion In FIG. 19A, the original data flow path from FIGS. 13A-13D is normally from R1 1910 to R3 1930to R5 1950. However in the this scenario, in the R3 node 1930 detects congestion and sends out an alarm packet 1935 to adjacent nodes, R1 1910, R4 1940, and R5 1950. In state 1900A, packet 1 1960 has already reached node R5 1950, who is forwarding a query 1980A for Packet 2 1970 currently at node R1 1910. Upon receiving the alarm packet 1935, node R1 1910 stops sending packets to R3 1930. Thus, node R1 1910 detect that Packet 2 1970 can no longer be sent to node R3 1930, and as a result, it changes Packet 2 1970 into a router packet and determines an alternate node route. In this case, R1 1910 can send Packet 2 1970 to R2 1920.

In FIG. 19B that depicts an example of a data flow state 1900B after the other nodes receive an error message 1935, Packet 2 1970 arrives at node R2 1920, and node R1 1910 sends a backward query 1980B to the previous node in the path (not illustrated ). Because Packet 2 1970 is a router packet, R2 1920 will determine the next node in the path, regardless of the path taken by packet 1, 1960.

In FIG. 19C that depicts an example of a data flow state 1900C after an alternative routing path is established by node R2 1920 in response to the Packet 2 1970 modified role as a router packet. In 1900C, R2 1920 sends Packet 2 1970 to R4 1940, and sends a backward query 1980C to R1 seeking the next packet.

Turning now to the data flow state 1900D in FIG. 19D, R4 1940 determines that Packet 2 1970 should be routed to R5 1950 and sends it. R4 1940 sends a backward query to R2 1920. R1 1910 sends Packet 3 1990 to R2 1920, according to the path defined by Packet 2 1970. In this way, the path has now been rerouted around the congested node R3 1930.

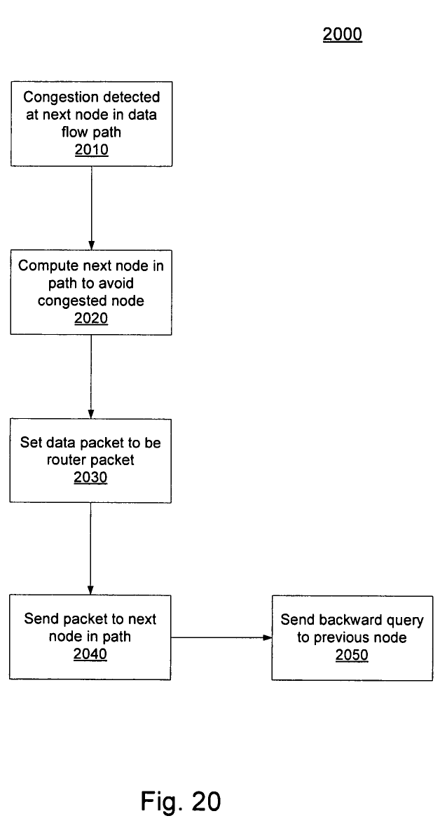

FIG. 20 depicts the steps in a data flow congestion method 2000. The data flow congestion method 2000 starts with the detection of congestion or other failure at the next mode in the data flow path, step 2010. For example, the above description of the packet record 1000 described the use of the error counters 1030 and 1040 to determine the failure of a packet transfer, and multiple such occurrences may signify congestion or other problems at on the nodes. In step 2020, the node determines a next node in a path to avoid the congestion area, and this generally accomplished using known packet routing techniques. The current data packet is designated as a router node, step 2030, and sent to that next node identified in step 2020, step 2040. The node then returns a backwards query to the previous node to request the next packet in step 2050, thereby completing the adjustment of the data path. For example, the description of FIG. 19A described the re-designation of packet 2 1970 as a router packet and the establishment of new path, where the congested node R3 1930 was removed from the realm of possible pathways.

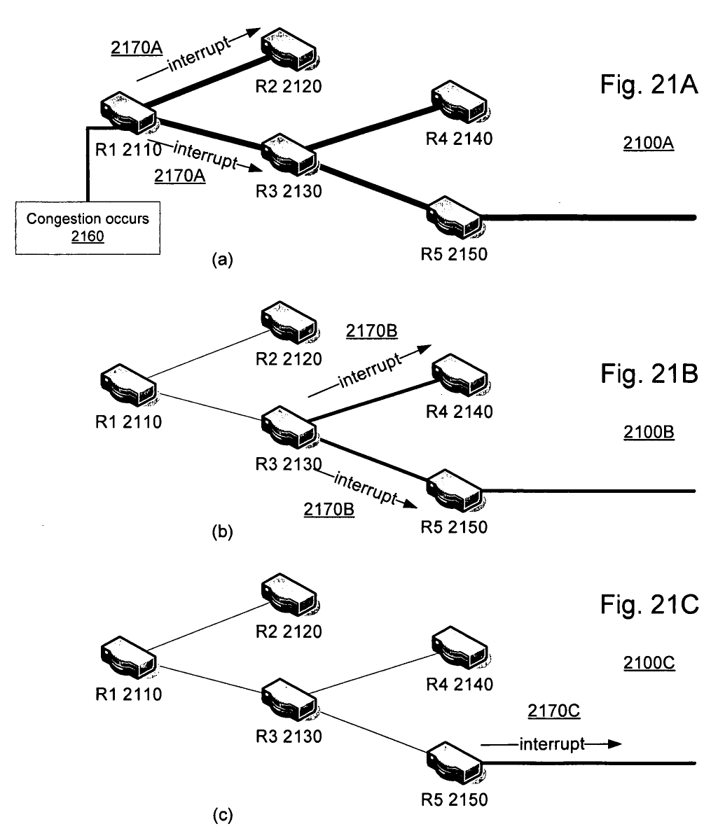

Alternatively, FIGS. 21A-21C illustrate an example of a multicast stream interrupted by congestion. In the multicast network 2100a of FIG. 21A, there is an existing multicast stream from R1 node 2110 to R2 node 2120 and R3 node 2130, from R3 node 2130 to R4 node 2140 and R5 node 2150, and from R5 node 2150, onto a downstream receiver (not depicted). The upstream node 2160 that sends the stream to R1 node 2110 is congested or offline. R1 node 2110 is expecting more packets on the stream, and R1 node 2110 will time out waiting for the stream if no more packets arrive. In the example, R1 node 2110 actually times out. The time out triggers the breakdown of the multicast trail leading out of R1 node 2110. R1 node 2110 sends interrupt stream packets 2170A along the stream path to R2 node 2120 and R3 node 2130. R1 node 2110 then removes its record of the stream.

In the multicast network 2100B of FIG. 21B, R2 node 2120 and R3 node 2130 send interrupt stream packets 2170B to any connected nodes on the stream. In the case of R3 node 2130, it sends interrupt stream packets 2170B to R4 node 2140 and R5 node 2150. R2 node 2120 and R3 node 2130 then remove their records of the stream.

In the multicast network 2100C of FIG. 21C, R4 node 2140 and R5 node 2150 send interrupt stream packets 2170C to any connected nodes on the stream. In the case of R5 node 2150, it sends an interrupt stream packets 2170C on the illustrated link to the downstream requester. The R4 node 2140 and R5 node 2150 then remove their records of the stream. This process will continue until the entire multicast path from R1 to receivers is deleted. Once the downstream receiver discovers that the stream has been interrupted, it will attempt to find a new path to the source or attempt to find an alternate server for the same stream.

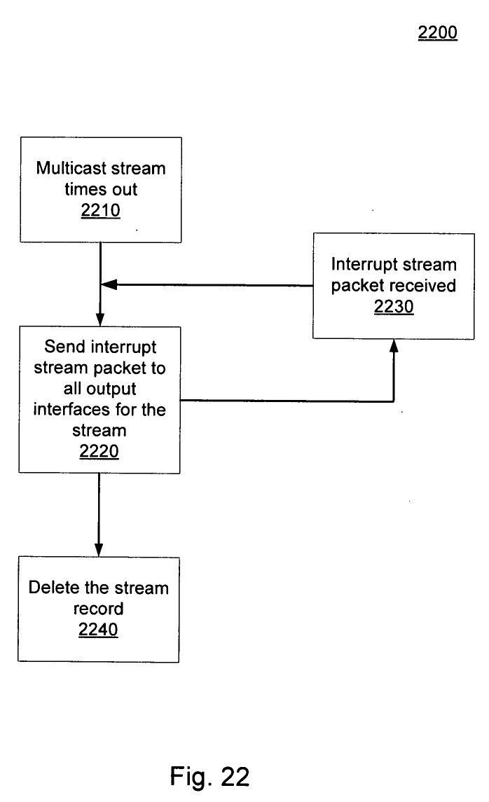

Thus, it can be seen that the present invention enables a multicast congestion method 2200, as provided in FIG. 22. In the multicast congestion method 2200, a multicast stream first times out in step 2210 dues to various technical or network problems. In response, the node then sends out interrupt stream packets to the output interfaces associated with the stream, step 2220. The node originally receiving the service time-out in step 2210 and the other nodes receiving the interrupt stream packets in step 2230, then delete the stream record in step 2240, thereby forcing the downstream requester to create a new breadcrumb pathway for the multicast stream.

The embodiments of the present invention includes two mechanisms for congestion control: preventive congestion control and reactive congestion control. The preventive congestion control system requires each node to update its adjacent nodes on its congestion status. In that way, adjacent nodes can selectively restrict traffic in order to allow congestion to clear. The reactive congestion control system allows a node to reroute packets away from slow outgoing interfaces.

In contrast, the preventive congestion system requires each node to maintain a set of flags indicating types of congestion: one flag for each quality of service, and one flag for each packet type. The entire set of flags will be sent to each adjacent node periodically. In the preferred embodiment, the set of flags is piggybacked on ACK and NACK messages.

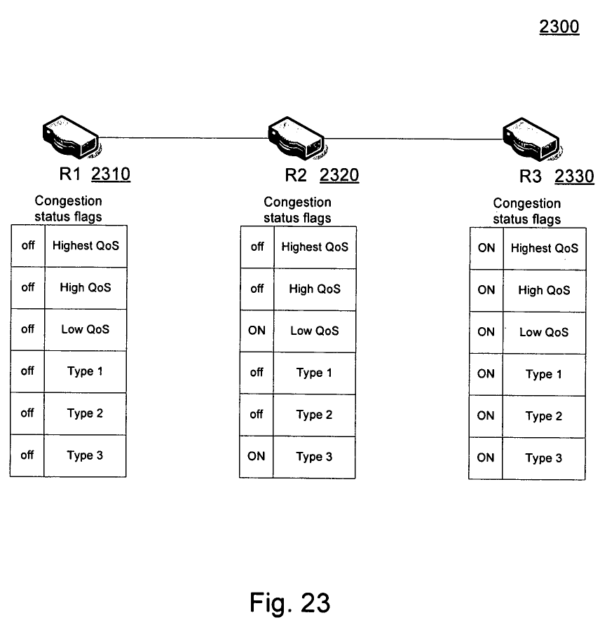

FIG. 23 illustrates a possible system state 2300 for three adjacent nodes, node R1 2310, node R2 2320, and node R2 2330. In the system state 2300, node R1 2310 has no congestion for all qualities of service and data types, node R2 2320 has partial congestion at certain quality of service and data types, and node R3 2330 has full congestion for all qualities of service and data types. Node R2 2320 could send any packets to node R1 2310, but not node R3 2330. The only packets that node R2 2320 may send to node R3 2330 are from streams and flows that already use node R3 2330. Thus, if there were a data flow already existing that included the link from node R2 2320 to node R3 2330, node R2 2320 would continue to send data packets from that flow on to node R3 2330, but no new router packets would be sent to node R3 2330. Node R2 2320 is only congested for the lowest quality of service and packets of type 3. Thus, node R1 2310 and node R3 2330 can freely send packets with higher qualities of service and of types 1 or 2 to node R2 2320. node R1 2310 and node R3 2330 may not send packets of the lowest quality of service or of type 3 to node R2 2320.

It will be apparent to those skilled in the art that various modifications and variations can be made in the present invention without departing from the spirit or scope of the invention. Thus, it is intended that the present invention cover the modifications and variations of this invention provided that they come within the scope of any claims and their equivalents.

What is claimed:

1. An improved method for transporting data packets of multi-cast, real-time stream, and file data over a computer network comprising a plurality of nodes, the improvement comprising the step of defining a homogeneous network protocol and defining distinct qualities of service, respectively, to the multi-cast, the real-time stream, and the file data.

2. The improved method of claim 1 further comprising the step of unpacking multi-packets at each nodes in the computer network.

3. The improved method of claim 1 further comprising the step of dynamic data packet routing between the nodes.

4. The improved method of claim 3 further comprising the step of employing congestion control.

5. The improved method of claim 4, where in the congestion control comprises each of the nodes forwarding a congestion status to adjacent nodes, and each of nodes routing received data away from a congested node.

6. The improved method of claim 5 wherein the nodes prioritizes higher quality of service traffic during the employing of the congestion control.

7. The improved method of claim 3 wherein a data path is not stored in data packets.

8. The improved method of claim 7 wherein the data path is dynamically recomputed around congestion or failed nodes.

9. The improved method of claim 1 further comprising the step of Multicast data routing using a bread crumb trail.

10. A method of dynamic congestion control on computer network comprising a plurality of nodes, the method comprising each of the node forwarding an associated congestion status to adjacent nodes, and each of nodes routing data away from any nodes having a positive congestion status.

11. The method of claim 10 further comprising the steps of defining a homogeneous network protocol and defining distinct qualities of service, respectively, to the multi-cast, the real-time stream, and the file data.

12. The method of claim 11 wherein the nodes prioritizes higher quality of service traffic during the employing of the congestion control.

13. The method of claim 11 wherein a data path is not stored in data packets.

14. The method of claim 13 wherein the data path is dynamically recomputed around congestion or failed nodes.

15. The method of claim 13 further comprising the step of Multicast data routing using a bread crumb trail.

16. The method of claim 13 further comprising the step of unpacking multi-packets unpacked nodes in the computer network.

17. The method of claim 16 further comprising the step of dynamic data packet routing between the nodes.

18. An improved network data packet header comprising a data type field.

19. The improved network data packet header of claim 18 further comprising a quality of service field.

20. The improved network data packet header of claim 18 further comprising a sub-type field.

21. The improved network data packet header of claim 18 further comprising a next area type field.

22. The improved network data packet header of claim 18 further comprising a maximum hops field.
